(19) United States
(12) Patent Application Publication
(10) Pub. No.: US 2023/0161015 A1
(43) Pub. Date: May 25, 2023

(54) METHOD AND APPARATUS FOR IMPROVING LASER BEAM RANGING CAPABILITY OF LIDAR SYSTEM, AND STORAGE MEDIUM THEREOF

(71) Applicant: SUTENG INNOVATION TECHNOLOGY CO., LTD., Shenzhen (CN)

(72) Inventors: Shen JIANG, Shenzhen (CN); Bin TAN, Shenzhen (CN)

(73) Assignee: SUTENG INNOVATION TECHNOLOGY CO., LTD., Shenzhen (CN)

(21) Appl. No.: 18/090,398

(22) Filed: Dec. 28, 2022

Related U.S. Application Data
(63) Continuation-in-part of application No. PCT/CN2021/137986, filed on Dec. 14, 2021.

(30) Foreign Application Priority Data
Nov. 23, 2021 (CN) 202111397377.1
Dec. 29, 2021 (CN) 202111636671.3

(51) Int. Cl. G01S 7/487; G01S 17/10

(52) U.S. Cl. CPC G01S 7/4876; G01S 17/10

(57) ABSTRACT

A method and apparatus for improving laser beam ranging capability of a LiDAR system and a storage medium are provided. The method includes: acquiring a first current signal output by a receiving sensor and a second current signal output by a reference sensor; determining a cancellation residue based on the first current signal and the second current signal; determining whether glare noise exists in echo lights based on the cancellation residue; and adjusting a bias voltage at a receiving end of the LiDAR system in a case that the glare noise exists in the echo lights.

### CROSS-REFERENCE TO RELATED APPLICATION

The present application is a continuation-in-part of International Patent Application No. PCT/CN2021/137986, filed on Dec. 14, 2021, which claims the benefit of priority to China Patent Application No. CN 202111397377.1, filed on Nov. 23, 2021, and also claims the benefit of priority to China Patent Application No. CN 202111636671.3, filed on Dec. 29, 2021. The contents of the abovementioned applications are incorporated herein by reference in their entireties.

### TECHNICAL FIELD

The present application relates to the field of measurement, and in particular to a method and apparatus for improving the laser beam ranging capability of a LiDAR system and a storage medium.

### BACKGROUND

In recent years, autonomous vehicle with LiDAR is in a vigorous development period. A sensor arranged at a receiving end of the LiDAR system in the related art can adopt a single photon avalanche diode (SPAD) with relatively high photoelectric detection capability, but the high-gain characteristic of the SPAD may cause the SPAD to be particularly sensitive to ambient light and thus easily influenced by the ambient light.

When external ambient light becomes strong, the SPAD can continuously excite more micro units to work, such that the average working current increases. In this way, the internal temperature rise of the LiDAR system correspondingly increases when heat dissipation conditions are constant, and the target detection failure may be caused due to the fact that the SPAD fails in a high-temperature environment or outputs abnormal waveforms. Therefore, how to identify glare noise so as to reduce the effect of glare is an urgent technical problem to be solved in the art.

### SUMMARY

The embodiments of the present application provide a method and apparatus for improving laser beam ranging capability of a LiDAR system and a storage medium.

In a first aspect, an embodiment of the present application provides a method for improving laser beam ranging capability of a LiDAR system, wherein the LiDAR system includes: a laser emitter for emitting pulse laser beams, a receiving sensor for receiving echo light, and a reference sensor in a shading state, wherein the receiving sensor and the reference sensor are positioned at a receiving end of the LiDAR system; the method includes the following steps:

acquiring a first current signal output by the receiving sensor and a second current signal output by the reference sensor;

determining a cancellation residue based on the first current signal and the second current signal;

determining whether glare noise exists in the echo light based on the cancellation residue; and

adjusting a bias voltage at the receiving end of the LiDAR system in a case that the strong light noise exists in the echo light.

In a second aspect, an embodiment of the present application provides an apparatus for improving laser beam ranging capability of a LiDAR system, wherein the LiDAR system includes: a laser emitter for emitting pulse laser beams, a receiving sensor for receiving echo light, and a reference sensor in a shading state, wherein the receiving sensor and the reference sensor are positioned at a receiving end of the LiDAR system; the apparatus includes:

an acquiring module, configured for acquiring a first current signal output by the receiving sensor and a second current signal output by the reference sensor;

a first determining module, configured for determining a cancellation residue based on the first current signal and the second current signal;

a second determining module, configured for determining whether glare noise exists in the echo light based on the cancellation residue; and

an adjusting module, configured for adjusting a bias voltage at the receiving end of the LiDAR system in a case that the strong light noise exists in the echo light.

In a third aspect, an embodiment of the present application provides an electronic device, which includes: a processor and a memory, wherein the memory has a computer program stored thereon, and the computer program, when loaded and executed by the processor, is adapted to implement the method steps provided in the second aspect of the embodiment of the present application.

In a fourth aspect, an embodiment of the present application provides an electronic device, which includes: a processor and a memory, wherein the memory has a computer program stored thereon, and the computer program, when loaded and executed by the processor, is adapted to implement the method steps provided in the third aspect of the embodiment of the present application.

The beneficial effects brought by the technical solutions provided in some embodiments of the present application at least include the followings.

In the embodiment of the present application, a first current signal output by a receiving sensor and a second current signal output by a reference sensor can be acquired; a cancellation residue is determined based on the first current signal and the second current signal; whether glare noise exists in echo light is determined based on the cancellation residue; and a bias voltage at a receiving end of the LiDAR system is adjusted in a case that the glare noise exists in the echo light. Therefore, in the embodiment of the present application, whether glare noise exists in the echo light can be detected by arranging the receiving sensor and the reference sensor at the receiving end of the LiDAR system, and if yes, the bias voltage at the receiving end is reduced to reduce the average current of the receiving sensor and reduce noise excitation, so that the accuracy of the ranging capability of the LiDAR system is improved.

### BRIEF DESCRIPTION OF THE DRAWINGS

In order to more clearly illustrate the technical solutions in the embodiments of the present application, the drawings are briefly described below. The drawings in the description below are only some embodiments of the present application, and other drawings can be derived from these drawings by those skilled in the art without making creative efforts.

FIG. 1 is an application scenario diagram of a method for improving the laser beam ranging capability of a LiDAR system according to an embodiment of the present application;

FIG. 2a is a structural block diagram of a LiDAR receiving apparatus according to an embodiment of the present application;

FIG. 2b is a schematic diagram of a waveform at a pulse laser beam receiving end of a LiDAR system under normal ambient light conditions according to an embodiment of the present application;

FIG. 2c is a schematic diagram of an implementation of a transimpedance amplifier circuit according to an embodiment of the present application;

FIG. 2d is a schematic diagram of an implementation of another transimpedance amplifier circuit according to an embodiment of the present application;

FIG. 3 is a schematic diagram of a waveform at a pulse laser beam receiving end of a LiDAR system under a glare irradiation condition according to an embodiment of the present application;

) FIG. 4 is a schematic flowchart of a method for improving the laser beam ranging capability of a LiDAR system according to an embodiment of the present application;

FIG. 5 is a schematic diagram of a waveform when a preset bias control signal is applied to a receiving sensor and a reference sensor in a LiDAR system according to an embodiment of the present application;

FIG. 6 is a schematic flowchart of another method for improving the laser beam ranging capability of a LiDAR system according to an embodiment of the present application;

FIG. 7 is a waveform diagram of echo light received by a receiving sensor at a receiving end according to an embodiment of the present application;

FIG. 8 is a schematic flowchart of another method for improving the laser beam ranging capability of a LiDAR system according to an embodiment of the present application;

FIG. 9 is another waveform diagram of echo light received by a receiving sensor at a receiving end according to an embodiment of the present application;

FIG. 10 is a schematic flowchart of yet another method for improving the laser beam ranging capability of a LiDAR system according to an embodiment of the present application;

FIG. 11A is a schematic diagram illustrating variations of a positive bias voltage before and after passing through a second-order pulse response system according to an embodiment of the present application;

FIG. 11B is a schematic diagram illustrating variations of a negative bias voltage before and after passing through a second-order pulse response system according to an embodiment of the present application;

FIG. 12A is a schematic diagram of a positive voltage variation curve of a receiving sensor according to an embodiment of the present application;

FIG. 12B is a schematic diagram of a negative voltage variation curve of a receiving sensor according to an embodiment of the present application;

FIG. 12C is a schematic diagram of variation curves with simultaneous variations of the positive voltage and the negative voltage of the receiving sensor according to an embodiment of the present application;

FIG. 13 is a schematic diagram illustrating variations in the positive bias voltage before and after updating a starting time of a preset time period according to an embodiment of the present application;

FIG. 14 is a schematic diagram illustrating variations in the positive bias voltage before and after updating a starting time of another preset time period according to an embodiment of the present application;

FIG. 15 is a schematic diagram illustrating variations in the positive bias voltage before and after updating a starting time of another preset time period according to an embodiment of the present application;

FIG. 16 is a schematic structural diagram of an apparatus for improving the laser beam ranging capability of a LiDAR system according to an embodiment of the present application;

FIG. 17 is a schematic diagram of circuits in an adjusting module according to an embodiment of the present application;

FIG. 18 is a schematic diagram of circuits in another adjusting module according to an embodiment of the present application;

FIG. 19 is a schematic diagram of circuits in yet another adjusting module according to an embodiment of the present application; and

FIG. 20 is a schematic structural diagram of an electronic device according to an embodiment of the present application.

### DETAILED DESCRIPTION

When accompanying drawings are involved in the description below, the same numbers in different drawings represent the same or similar elements, unless otherwise indicated. The modes of implementation described in the following exemplary embodiments do not represent all modes of implementation consistent with the present application. Rather, they are merely examples of apparatuses and methods consistent with certain aspects of the present application detailed in the appended claims.

In the description of the present application, it shall be understood that the terms “first,” “second,” and the like are used for descriptive purposes only and are not to be construed as indicating or implying relative importance. The specific meanings of the above terms in the present application can be understood according to specific situations by those of ordinary skill in the art. In addition, in the description of the present application, “a plurality of” refers to two or more unless otherwise specified. The term “and/or” describes an associative relationship between associated objects, and means that there may be three relationships, for example, A and/or B may represent that: A is present alone, A and B are present simultaneously, and B is present alone. The character “/” generally indicates an “or” relationship between the associated objects.

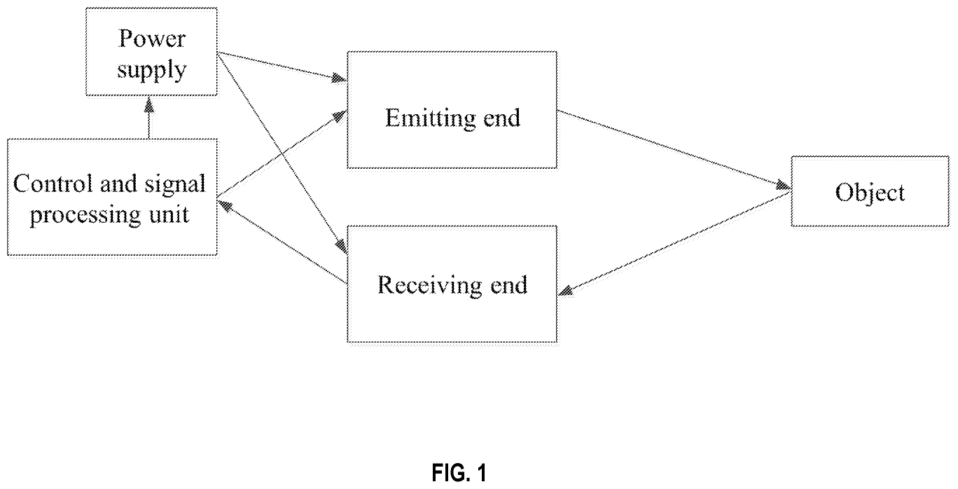

FIG. 1 exemplarily shows a schematic diagram of an application scenario of a method for improving the laser beam ranging capability of a LiDAR system according to an embodiment of the present application. The LiDAR system may include a power supply module, a control and signal processing unit, a pulse laser beam emitting end, and a pulse laser beam receiving end.

The control and signal processing unit of the LiDAR system may be utilized to control the power supply module to supply power to the pulse laser beam emitting end and the pulse laser beam receiving end, control the laser emitter of the pulse laser beam emitting end to emit pulse laser beams to an object and then calculate a distance between the LiDAR system and the object according to the time when the pulse laser beam receiving end receives the pulse laser beams.

As the photocurrent signal sent by the pulse laser beam emitting end is weaker than the bias current signal sent by the bias power supply, even though the two signals have a difference in magnitude, the photocurrent signal is difficult to detect by the pulse laser beam receiving end. Based on this, the pulse laser beam receiving end of the present application may include a receiving sensor and a reference sensor, where the reference sensor is in a shading state and is in a parallel state with the receiving sensor. The power supply module is integrated into the LiDAR receiving apparatus, such that the structure of the LiDAR receiving apparatus is more compact and the power supply mode is more convenient.

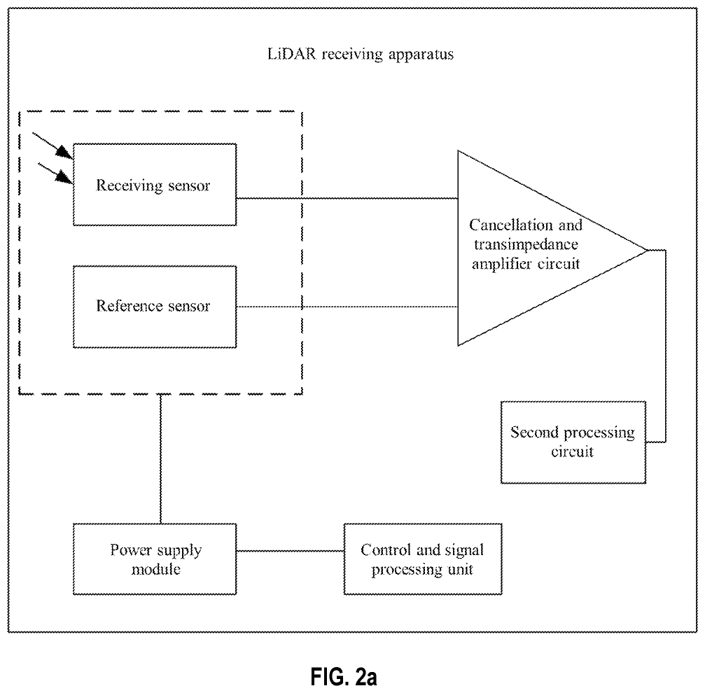

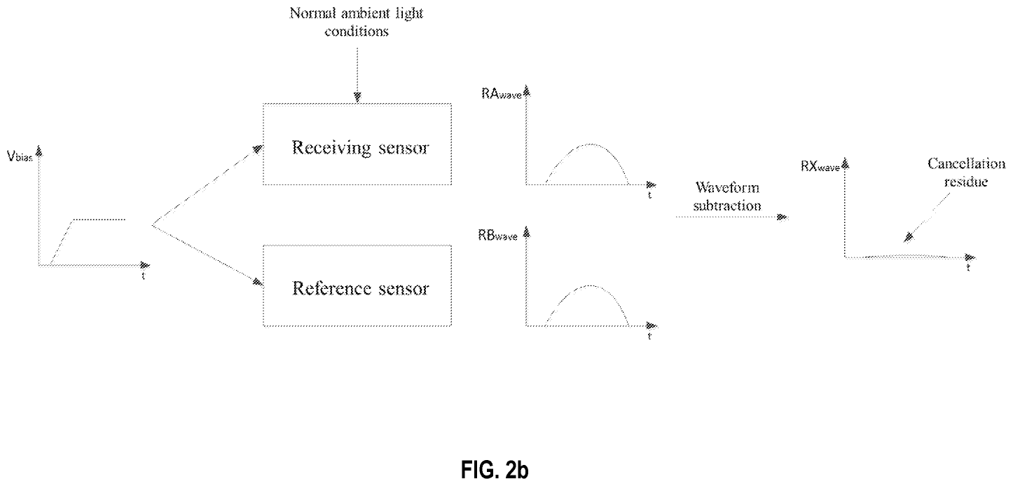

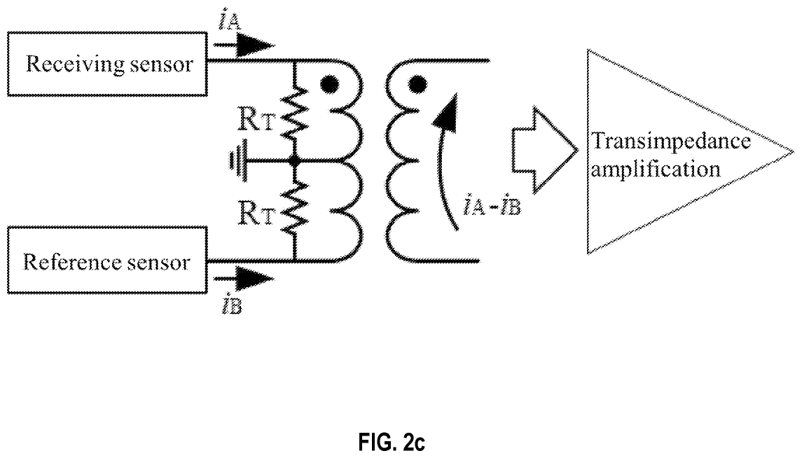

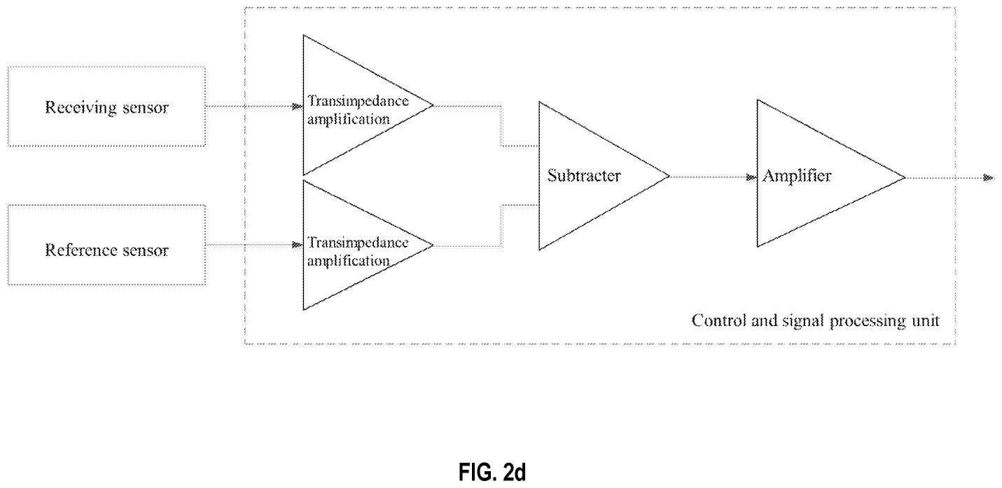

FIG. 2a is a structural block diagram of a LiDAR receiving apparatus. The receiving apparatus includes a receiving sensor and a reference photosensor, and the reference sensor is in a shading state and is connected in parallel with the receiving sensor. The receiving apparatus further includes a cancellation and transimpedance amplifier circuit. The cancellation and transimpedance amplifier circuit is respectively connected with the receiving sensor and the reference sensor, and is configured for performing cancellation and transimpedance amplification processing oncurrent signals output by the receiving sensor and the reference sensor, and for outputting voltage signals obtained after the cancellation and transimpedance amplification processing. The current signal output by the reference sensor is positively correlated with the bias voltage applied to the reference sensor by the power supply. The receiving apparatus further includes a second processing circuit connected with the cancellation and transimpedance amplifier circuits and configured for obtaining distance data through calculation according to the voltage signals obtained after the cancellation and transimpedance amplification processing.

It can be understood that, since the reference photosensor and the detection photosensor are connected in parallel, the bias voltage of the reference photosensor is equal to the bias voltage of the detection photosensor, i.e., the bias current signals of the reference photosensor and the detection photosensor are the same. Meanwhile, since the reference photosensor is in a shading state, the current signal output by the reference photosensor is a bias current signal at any time. Therefore, the voltage signal obtained after the cancellation and transimpedance amplification processing has been subjected to the cancellation processing, a bias voltage part is removed, and only a photovoltage part is remained, so that the voltage signal obtained after the cancellation and transimpedance amplification processing is a photovoltage signal at the time when the laser echo signal reaches the receiving sensor, and should be 0 except for the time when the laser echo signal reaches the receiving sensor. Therefore, the second processing circuit can sensitively detect the voltage signal obtained after the cancellation and transimpedance amplification processing, and take the time when the voltage signal obtained after the cancellation and transimpedance amplification processing is detected as the time when the laser echo signal reaches the detection photosensor, thus improving the sensitivity and the accuracy for detecting the laser echo signal, and also improving the accuracy of distance measurement.

The LiDAR receiving apparatus may further include a power supply module. The power supply module is connected to the receiving sensor and the control and signal processing unit, and is configured for receiving the control signal sent by the control and signal processing unit and applying the bias voltage corresponding to the control signal to the receiving sensor. It can be understood that when the reference photosensor is connected in parallel with the detection photosensor, the power supply module applies a bias voltage to the detection photosensor and simultaneously applies the same bias voltage to the reference photosensor. The power supply module is integrated into the LiDAR receiving apparatus, such that the structure of the LiDAR receiving apparatus is more compact and the power supply mode is more convenient.

Referring to FIG. 2b, under normal ambient light conditions, when the laser emitter at the pulse laser beam emitting end does not emit pulse laser beams, the cancellation residue is 0 after the voltage signal waveform generated by the receiving sensor is subtracted from that of the reference sensor. Furthermore, after the laser emitter at the pulse laser beam emitting end emits the pulse laser beam to the object, the receiving sensor receives a voltage signal obtained by cancellation and transimpedance amplification processing of echo light of the pulse laser beam, so that the time when the echo light reaches the receiving sensor can be determined, and the voltage signal should be 0 except for the time when the echo light reaches the receiving sensor.

FIG. 2c shows an implementation of the cancellation and transimpedance amplifier circuits. Current signals output by the receiving sensor and the reference sensor are respectively input to two ends of a balanced side of a balun transformer, a residual current after cancellation is coupled to a primary side through the transformer, and then the current signals are input to a transimpedance amplifier for transimpedance amplification, so as to obtain a voltage signal after transimpedance amplification processing. A balun transformer with low insertion loss and high symmetry may be used, that is, a balun transformer with reduced signal attenuation and good cancellation processing performance, so that a photocurrent signal range close to the output of a single photosensor can be obtained. In terms of noise, the thermal noise of the matching resistor RT is mainly increased, which is much smaller than the current noise of the transimpedance amplifier circuit itself (the noise exists in the transimpedance amplification process), and the influence on the signal-to-noise ratio of the photocurrent signal is basically negligible; that is, only a very small amount of thermal noise is added, while the photocurrent signal is basically not attenuated, so the influence on the signal-to-noise ratio is small. Therefore, the photocurrent signal amplification capability of the circuit is hardly reduced.

FIG. 2d shows another implementation of the cancellation and transimpedance amplifier circuits. Current signals output by the receiving sensor and the reference photosensor are respectively input to the transimpedance amplifier for primary amplification, amplified voltage signals are output, then the two paths of amplified voltage signals are input to a subtractor, the voltage signals after cancellation are output, and then secondary amplification is performed on the voltage signals after cancellation. It can be understood that the present application does not limit the specific form of the transimpedance amplifier circuit.

It can be understood that, in the LiDAR with the receiving and cancellation architecture as shown in FIG. 2a, two sensor waveforms undergo cancellation to output real echoes. However, under the glare condition, the sensor receiving the echo is irradiated by the glare, the temperature rises rapidly, while the temperature of the other cancellation reference register does not change synchronously, which causes the breakdown voltages or other equivalent parameters of the two sensors to diverge and no longer match, and leads to the increase of cancellation residue. The larger the temperature difference is, the larger the cancellation residue is. Especially for a single photon sensor, the high-gain characteristic makes it particularly sensitive to ambient light, and a sharp rise in temperature in a glare environment can lead to detection failure.

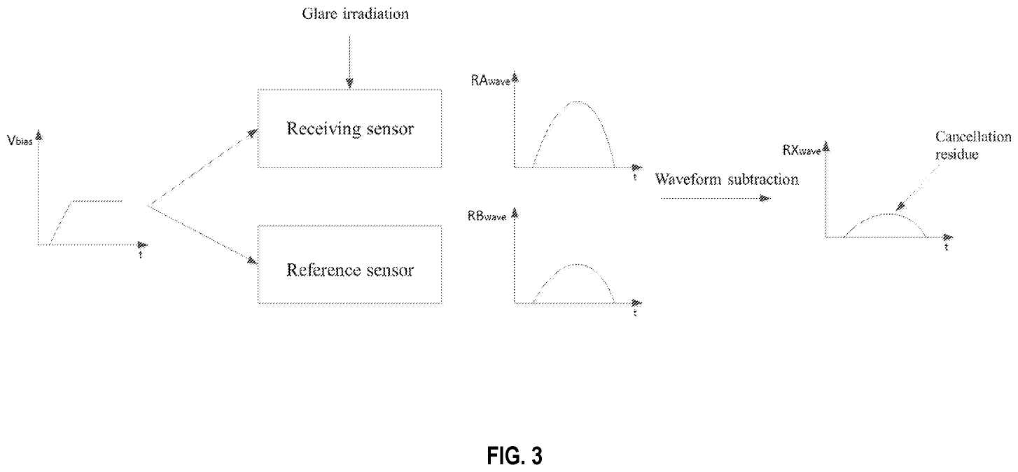

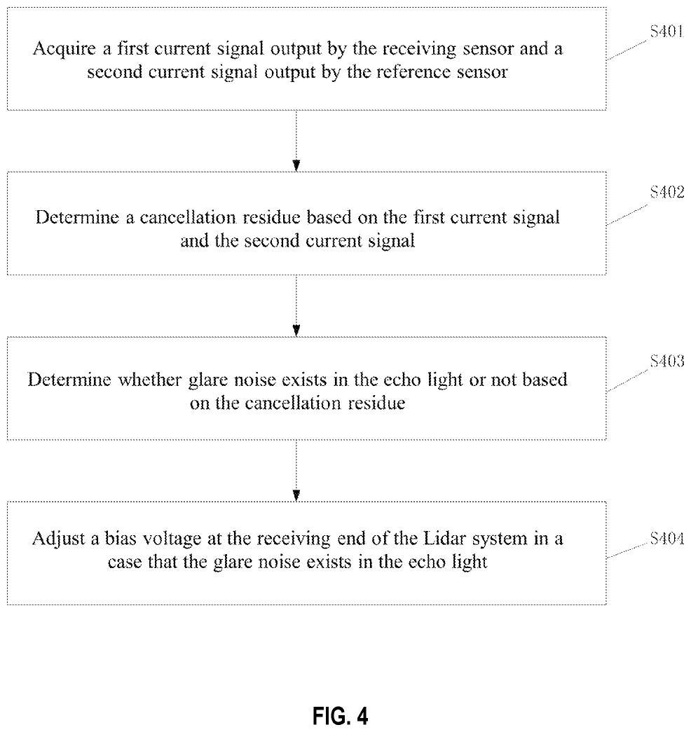

FIG. 3 shows that when the laser emitter at the pulse laser beam emitting end does not emit pulse laser beams under strong ambient light conditions, the cancellation residue is not 0 after the voltage signal waveform generated by the receiving sensor is subtracted from that of the reference sensor due to the influence of glare irradiation. It can be understood that, in the receiving end based on the cancellation architecture as shown in FIG. 3, the two sensor waveforms undergo cancellation to output real echoes. However, as the sensor receiving the echo is irradiated by glare, the temperature rises rapidly, while the temperature of the other cancellation reference sensor does not change synchronously, which causes the breakdown voltages or other equivalent parameters of the two sensors to diverge and no longer match, and leads to the increase of cancellation residue. The larger the temperature difference is, the larger the cancellation residue is. It can be understood that under glare irradiation, the average working current of the receiving sensor increases, the power consumption increases, and therefore, under a certain heat dissipation condition, the temperature increases, which may result in the failure of the target detection due to the fact that the receiving sensor fails at high temperature or outputs abnormal waveforms.

The present disclosure aims to weaken the glare noise influence in the ambient light by adopting the following modes:

1) Reducing the Amount of Ambient Light Entering the Pulse Laser Beam Receiving End

Structural designs such as extinction and light blocking may be added in the LiDAR system to reduce the external ambient light entering the surface of the receiving sensor through the non-main light path; and/or the bandwidth of the receiving filter may be reduced to reduce the amount of the ambient light entering the main light path;

2) Adding a Heat Dissipation Unit in the LiDAR System

As the receiving sensor may excite redundant working units due to the influence of glare noise, such that the power consumption of the LiDAR system increases a heat dissipation unit may be added in the LiDAR system to reduce the heat generated by the receiving sensor;

3) Reducing Power Consumption of the LiDAR System

In addition, power consumption may be reduced to reduce the temperature rise of the receiving sensor, so that the influence of glare noise is weakened to reduce or eliminate false target points generated by the glare noise.

Next, the method for improving laser beam ranging capability of a LiDAR system provided in the embodiment of the present application will be introduced with reference to an application scenario diagram of a method for improving the laser beam ranging capability of a LiDAR system shown in FIG. 1, a schematic diagram of a waveform at a pulse laser beam receiving end of a LiDAR system shown in FIG. 2, and a schematic structural diagram of a pulse laser beam receiving end and a control and signal processing unit in the LiDAR system shown in FIG. 3, so as to further detect whether the influence of glare noise still exists in the pulse laser beam receiving end.

FIG. 4 shows a flowchart of a method for improving the laser beam ranging capability of a LiDAR system. The method may include the following.

S401, acquiring a first current signal output by the receiving sensor and a second current signal output by the reference sensor.

In some embodiments, noise under ambient light can be counted, cancellation coding can be performed by using the receiving sensor and the reference sensor after the pulse laser beams are emitted at a same time interval of the continuous detection period, double-cancellation internal coding can be performed by using the receiving sensor and the reference sensor after the pulse laser beams are emitted at different time intervals of the continuous detection period, or the pulse laser beams may not be emitted in one detection period, to detect the cancellation residue generated based on the receiving sensor and the reference sensor. The detection period is configured for representing a preset time period.

It can be understood that, in the embodiment of the present application, the noise statistics means that a noise threshold is set in advance, and the noise amount in the echo light within a preset time is counted. According to the characteristic that the noise density becomes very high under the condition of glare noise, whether glare irradiation exists under the current environmental condition can be determined. In some embodiments, the noise threshold may be set according to an actual test condition that the photon amplitude in the photodetection device and the silicon photomultiplier (SiPM) at the pulse laser beam receiving end is the photon amplitude or the multiphoton amplitude, and the preset time may be set to a time interval corresponding to a distance interval of 20 m to 200 m.

In the embodiment of the present application, the following steps may be performed before acquiring the first current signal output by the receiving sensor and the second current signal output by the reference sensor:

turning off the laser emitter; and applying a preset bias control signal to the receiving sensor and the reference sensor. The preset bias control signal controls the bias voltage at the receiving end to be smaller than a breakdown voltage in a stray light time period, and controls the bias voltage at the receiving end to be greater than the breakdown voltage in an echo light time period.

The bias voltage is configured for representing the voltage applied to the receiving sensor and the reference sensor.

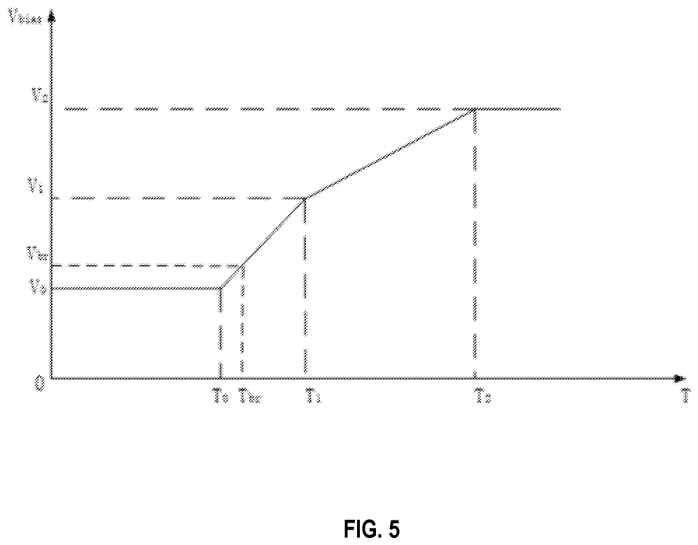

FIG. 5 shows a schematic diagram of a waveform when a preset bias control signal is applied to the receiving sensor and the reference sensor. The bias voltage applied by the control and signal processing unit in a first preset time period between an emission time T₀ and an initial time T_{br} is smaller than the breakdown voltage; the emission time is the emission time of the laser signal, and the initial time is later than the receiving time of the stray light signal, so that the first preset time period is a time period including the receiving time of the stray light signal, that is, the stray light time period. Furthermore, in the embodiment of the present application, the numerical value of the bias voltage can be continuously increased at the same rate in a second preset time period between the initial time T_{br} and the first time T₁. Furthermore, in the embodiment of the present application, a value of the bias voltage corresponding to the current moment may be determined according to a corresponding relation between the receiving time of laser echo signals and the bias voltage in a third preset time period between the first time T₁ and the second time T₂, and the applied bias voltage may also be adjusted according to the value of the bias voltage corresponding to the current moment.

Referring to FIG. 5, the laser emission time may be T₀, the initial time may be T_{br}, and since the initial time is later than the receiving time of stray light signals, in the first preset time period of 0-T_{br}, the bias voltage is smaller than the breakdown voltage V_{br}, and the photoelectric amplification gain is approximately zero, so that the excitation of the receiving sensor by the stray light signal is avoided. In the second preset time period and the third preset time period of T_{br}-T₂, that is, in the echo light time period, the bias voltage rises rapidly such that the photoelectric amplification factor of the receiving sensor increases rapidly, so as to ensure that the detection sensor can amplify the real laser echo signals after the stray light signals sufficiently and effectively, and the real laser echo signals can be detected. In the third preset time period of T₁-T₂, the LiDAR receiving apparatus may amplify the laser echo signals sufficiently and effectively. When short-distance ranging is performed in the second preset time period, the flight time of the laser echo signals is short, and the intensity of the laser echo signals is high, so that the gain requirement is low, and supersaturation is avoided; and when long-distance ranging is performed in the third preset time period, the flight time of the laser echo signals is long, and the intensity of the laser echo signals is low, so that the gain requirement is high, and the problem that the laser echo signals are undetectable is avoided.

S402, determining a cancellation residue based on the first current signal and the second current signal.

The laser emitter at the pulse laser beam emitting end may be utilized to emit pulse laser beams. When it is detected that a bias voltage applied to the receiving sensor is greater than a breakdown voltage of the receiving sensor, a first current signal output by the receiving sensor and a second current output by a reference sensor are acquired and detected. The first current signal is related to the laser echo signal corresponding to the emitted laser signal and the bias voltage, and the second current is related to the bias voltage.

In some embodiments, the echo light signal may excite the receiving sensor to detect the echo light signal, and generate a current signal of the echo light corresponding to the pulse laser beam emitted by the laser emitter, so as to generate a cancellation residue. However, due to the influence of the glare noise, the stray echo signal generated by the glare noise may also generate an echo light signal. Therefore, it is necessary to further determine whether the glare noise exists in the received cancellation residue.

S403, determining whether glare noise exists in the echo light based on the cancellation residue.

It can be understood that, in a case that the current ambient light is normal light, the cancellation residue between the receiving sensor and the reference sensor is 0. In a case that glare irradiation exists in the current ambient light, the cancellation residue between the receiving sensor and the reference sensor may not be 0, that is, the receiving sensor may receive echo light generated by glare noise.

Furthermore, in a case that the current ambient light is normal light and the laser emitter at the pulse laser beam emitting end emits pulse laser beams, the cancellation residue between the receiving sensor and the reference sensor is not 0, and the receiving sensor may detect a current signal generated by echo light of the pulse laser beam. In a case that glare irradiation exists in the current ambient light and the laser emitter at the pulse laser beam emitting end emits pulse laser beams, the cancellation residue between the receiving sensor and the reference sensor is not 0, and current signals detected by the receiving sensor may include not only a current signal generated by echo light of the pulse laser beam but also a current signal generated by glare noise.

S404, adjusting a bias voltage at the receiving end of the LiDAR system in a case that the strong light noise exists in the echo light.

The influence of glare noise may be reduced by reducing the bias voltage of the LiDAR system. Under the influence of glare noise, the noise output by the receiving sensor is high, and the temperature rises rapidly, which may cause the failure of cancellation. Therefore, in the embodiment of the present application, the excitation of the noise at the receiving end and the average current of the receiving sensor can be reduced by reducing the bias voltage, so as to ensure that the cancellation residue does not exceed the standard and false scenes of the cancellation residue are prevented.

For example, under the non-glare irradiation condition, the background noise at the pulse laser beam receiving end is low, and when the current bias voltage of the LiDAR system exceeds the breakdown voltage, the receiving sensor can detect a weak current signal so as to ensure the ranging capability of the LiDAR system under the non-glare condition. Under the glare irradiation condition, in the embodiment of the present application, the bias voltage can be reduced to the voltage reduction threshold such that the gain of the receiving sensor is reduced, that is, the amplitude of the noise is reduced in a case that the LiDAR system does not change the integral signal-to-noise ratio of the pulse laser beam receiving end.

The method for adjusting the bias voltage of the LiDAR system may include the following steps.

A temperature or a current of the receiving sensor is acquired. In the ranging process of the LiDAR system, the temperature sensor can be controlled to detect the temperature of the receiving sensor according to a preset time interval; or the current detecting module can be controlled to detect the current of the receiving sensor according to a preset time. The preset time interval described above may be 2 ms, 3 s, etc., which is not limited in the present application.

A target bias voltage is determined according to the received temperature or the received current. After the temperature or the current of the receiving sensor is acquired, the target bias voltage corresponding to the working temperature described above may be determined by inquiring a preset mapping relation. The preset mapping relation may be a temperature-bias voltage relation or a current-bias voltage relation. Due to the increase of the current, the heating effect of the receiving sensor may be intensified, and the temperature of the receiving sensor may increase; the current or the temperature may be detected, or both the current and the temperature may be detected simultaneously. The receiving capacity of the receiving sensor is related to the bias voltage. When the bias voltage of the same receiving sensor is unchanged, the receiving capability is different due to the change in the working temperature. The selected receiving sensor may obtain its temperature-bias voltage relation curve or current-bias voltage relation curve through measurement. Taking the temperature-bias voltage relation curve as an example, when the obtained working temperature of the receiving sensor is 40° C., the pressure difference ΔV corresponding to the temperature described above that can be obtained by inquiring the mapping relation curve is 30V, that is, when the working temperature of the receiving sensor is 40° C., the target bias voltage is 30V.

A voltage value applied to an anode and/or a cathode of the receiving sensor is adjusted according to the target bias voltage. A target bias voltage is determined based on the temperature or the current of the receiving sensor, and is adjusted to compensate for variations in temperature or current affecting the receiving capability of the receiving sensor.

In some embodiments, the duty ratio of the modulation signal applied to a negative electrode and/or a positive electrode of the power supply module is determined according to the target bias voltage. The modulation signal is sent to the power supply module, and the power is output to the anode and/or the cathode of the receiving sensor by the power supply module according to the modulation signal. For example, a voltage value applied to the cathode of the receiving sensor is detected and acquired; the voltage value required to be applied to the anode of the receiving sensor is determined according to the target bias voltage and the voltage value applied to the cathode of the receiving sensor; and the duty ratio of the modulation signal of the negative electrode of the power supply module is determined according to the voltage value of the anode of the receiving sensor, and the modulation signal is sent to the negative electrode of the power supply module. Or, a voltage value applied to the anode of the receiving sensor is detected and acquired; the voltage value required to be applied to the cathode of the receiving sensor is determined according to the target bias voltage and the voltage value applied to the anode of the receiving sensor; and the duty ratio of the modulation signal of the positive electrode of the power supply module is determined according to the voltage value of the cathode of the receiving sensor, and the modulation signal is sent to the positive electrode of the power supply module. When the receiving sensor is in a normal working state, the temperature or current of the receiving sensor may also be changed due to slow temperature change caused by factors such as working environmental temperature, self temperature rise, and device aging. At this moment, the bias voltage of the receiving sensor is adjusted to be in a good working state by sending modulation signals with different duty ratios to the positive electrode and/or the negative electrode of the power supply module, so that the dynamic adjustment of the bias voltage during the working period of the receiving sensor is realized, and the distance measurement range and the reliability of the LiDAR system are improved.

In some embodiments, a switching signal applied to a high-voltage amplifier of the power supply module is determined according to the target bias voltage, and the high-voltage amplifier switches gears according to the received switching signal to output different positive voltage values. For example, a first signal of low-gear switching is sent to a high-voltage amplifier, and the high-voltage amplifier outputs a low-gear positive voltage value, such as 1V; and a second signal of high-gear switching is sent to the high-voltage amplifier, and the high-voltage amplifier outputs a high-gear positive voltage value, such as 5V. The positive voltage value output by the high-voltage amplifier may also include a plurality of gears, such as 3 or 10 gears, which can be set according to an adjustment requirement and is not limited herein. When the receiving sensor is irradiated by glare, a large photocurrent is instantaneously generated, the temperature or current of the receiving sensor is suddenly changed, a positive voltage value is instantaneously pulled to a low gear by controlling a high-voltage amplifier with quick response, the bias voltage of the receiving sensor is quickly adjusted to be low, and a strong echo signal can be effectively received while the device is prevented from being damaged. When the glare irradiation is finished, the temperature or the current of the receiving sensor is reduced, the positive voltage value is switched back to a high gear by controlling the high-voltage amplifier, and the normal working state is recovered. The instant blindness of the LiDAR system caused by glare irradiation is avoided, and the detection capability is improved.

In some embodiments, determining a target bias voltage according to the received temperature or the received current and adjusting a voltage value applied to an anode and/or a cathode of the receiving sensor according to the target bias voltage may also be: determining whether the temperature or the current of the receiving sensor meets a preset condition. If yes, determining a duty ratio of a modulation signal applied to a negative electrode and/or a positive electrode of the power supply module according to the target bias voltage; if no, determining a switching signal applied to a high-voltage amplifier of the power supply module according to the target bias voltage, and switching gears by the high-voltage amplifier according to the received switching signal to output different positive voltage values. The preset condition met by the temperature or the current of the receiving sensor refers to a sudden change in the temperature or the current. The temperature or the current of the receiving sensor detected at the current time may be compared with the previous detection result. If the difference value of the two detection results is greater than the threshold, the temperature or the current of the receiving sensor is considered to be suddenly changed; if the difference value of the two detection results is smaller than or equal to the threshold, the temperature or the current of the receiving sensor is considered to have no sudden change. When the temperature or the current of the receiving sensor changes suddenly, it means that a large photocurrent is instantaneously generated, with the receiving sensor being irradiated by glare, a positive voltage value is instantaneously pulled to a low gear by controlling a high-voltage amplifier with quick response, the bias voltage of the receiving sensor is quickly adjusted to be low, and a strong echo signal can be effectively received while the device is prevented from being damaged. When the glare irradiation is finished, the temperature or the current of the receiving sensor is reduced, the positive voltage value is switched back to a high gear by controlling the high-voltage amplifier, and the normal working state is recovered. When the temperature or the current of the receiving sensor does not change suddenly, it means that the receiving sensor is in a normal working state, and a bias voltage does not need to be adjusted instantaneously and quickly. However, the temperature or current of the receiving sensor can also be changed due to slow temperature change caused by factors such as the environmental temperature of the receiving sensor, the self temperature rise, and the device aging. At this moment, the bias voltage of the receiving sensor is adjusted to be in a good working state by sending modulation signals with different duty ratios to the positive electrode and/or the negative electrode of the power supply sub-circuit through the control sub-circuit, so that the dynamic adjustment of the bias voltage during the working period of the receiving sensor is realized, and the distance measurement range and the reliability of the LiDAR system are improved.

In the embodiment of the present application, the influence of glare noise can be avoided in a voltage reduction mode of the emitting end. For example, a main pulse laser beam and a sub pulse laser beam may be emitted in two consecutive detection periods, respectively. An emission power of the main pulse laser beam emitted for the first time is higher than an emission power of the sub pulse laser beam emitted for the second time. The influence of glare noise is avoided by reducing the voltage corresponding to the emission power of the main pulse laser beam.

It can be understood that the main pulse laser beam has a high emission power and can be configured for detecting objects at long distances, for example, in a range of 15 meters to 60 meters. The sub pulse laser beam has a low emission power and can be configured for detecting objects at short distances, for example, objects within 15 meters.

In the embodiment of the present application, when the voltage corresponding to the emission power of the emitted main pulse laser beam is reduced to a preset constant voltage value during the remote detection, the bias voltage corresponding to the receiving end is correspondingly reduced after the emitting end emits a photon signal, so that the average current of the receiving sensor is reduced to prevent the cancellation residue from exceeding the cancellation threshold, and false scenes of the cancellation residue are avoided. In addition, since the voltage corresponding to the emission power of the emitted sub pulse laser beam is relatively low, no adjustment is required.

In the embodiment of the present application, point cloud filtering on glare noise in the echo light may be performed. For example, after glare noise data in the point cloud data of the echo light are removed by using the time domain characteristics of the echo light data, smoothing filtering or feature extraction is performed on the echo light data of the pulse laser beam.

In the embodiment of the present application, a first current signal output by a receiving sensor and a second current signal output by a reference sensor are acquired. A cancellation residue is determined based on the first current signal and the second current signal. Whether glare noise exists in echo light is determined based on the cancellation residue. A bias voltage at a receiving end of the LiDAR system is adjusted in a case that the glare noise exists in the echo light. Therefore, in the embodiment of the present application, whether glare noise exists in the echo light can be detected by arranging the receiving sensor and the reference sensor at the receiving end of the LiDAR system. If yes, the bias voltage at the receiving end is reduced to reduce the average current of the receiving sensor and reduce noise excitation, so that the accuracy of the ranging capability of the LiDAR system is improved.

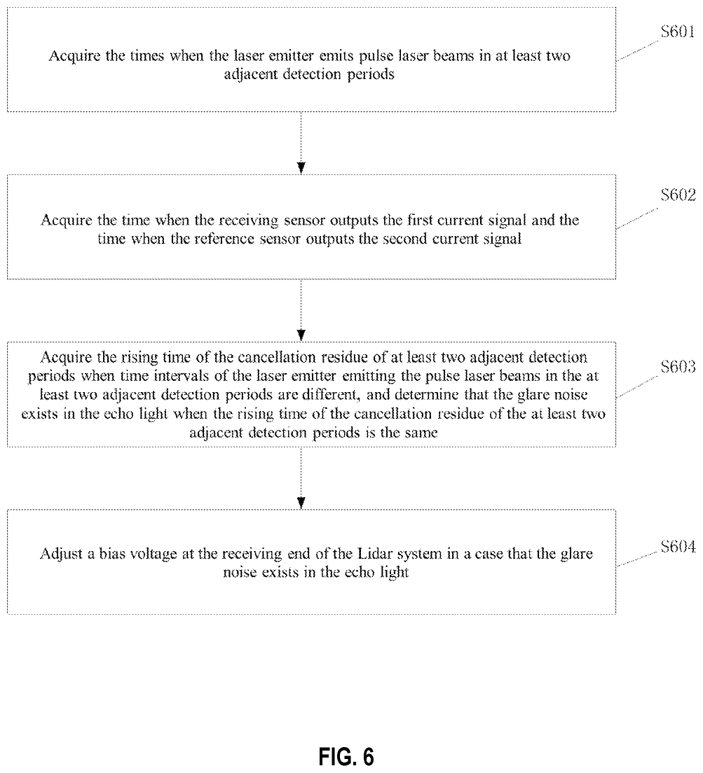

FIG. 6 shows a schematic flowchart of another method for improving the laser beam ranging capability of a LiDAR system according to an embodiment of the present application. In a case that the emission power of the pulse laser beams of the laser emitter in at least two adjacent detection periods is the same, as shown in FIG. 6, the method for improving the laser beam ranging capability of a LiDAR system at least includes the following steps.

S601, acquiring times when the laser emitter emits the pulse laser beams in the at least two adjacent detection periods.

The pulse laser beams with the same emission power can be understood as the same emission voltage at the emitting end.

In the embodiment of the present application, the time when the laser emitter emits the pulse laser beams in each detection period in a plurality of detection periods is continuously acquired in a case that the voltages at the emitting end are the same.

S602, acquiring the time when the receiving sensor outputs the first current signal and the time when the reference sensor outputs the second current signal.

In the embodiment of the present application, the occurrence time of a first current signal corresponding to echo light when the receiving sensor detects the echo light and the time when the reference sensor outputs a second current signal within the corresponding time can be recorded.

S603, acquiring rising times of cancellation residues of the at least two adjacent detection periods when time intervals of the laser emitter emitting the pulse laser beams in the at least two adjacent detection periods are different, and determining that the glare noise exists in the echo light when the rising times of the cancellation residues of the at least two adjacent detection periods are the same.

It can be understood that the emission power of the LiDAR system in two adjacent detection periods is the same, and accordingly, the time when the bias voltages are applied to the receiving sensor and the reference sensor is also the same.

In some embodiments, the rising time of the bias voltages on the receiving sensor and the reference sensor are configured for indicating the time when the bias voltages start to increase from a constant voltage. For example, in FIG. 5, the bias voltage is a constant voltage V₀ before time T₀, and the bias voltage starts to increase after time T₀, that is, time T₀ indicates the rising time of the bias voltage at the receiving end of the LiDAR system.

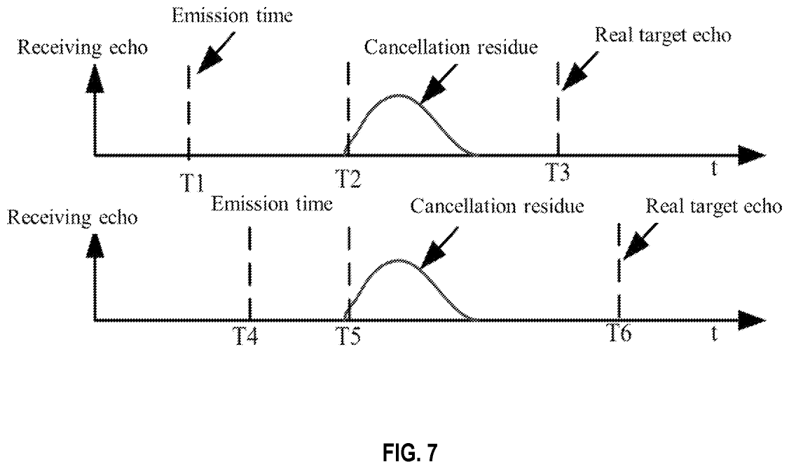

Referring to FIG. 7, the emission power of the LiDAR system in two adjacent detection periods is the same, the pulse laser beam emission time T₁ in the first detection period 1S is 0.5 ms, and the pulse laser beam emission time T₄ in the second detection period 1S is 1.6 ms. That is, in the case of different emission time intervals, the first current signal output by the receiving sensor and the second current signal output by the reference sensor in the two detection periods are acquired.

In the embodiment of the present application, the bias voltage at the receiving end of the LiDAR system can be recovered to the initial state V₀ at the beginning of each detection period.

Referring to FIG. 7, the pulse laser beam emission time in the first detection period is T₁, the cancellation residue generation time is T₂, the time of receiving the real target echo of the object is T₃, the pulse laser beam emission time in the second detection period is T₄, the cancellation residue generation time is T₅, and the time of receiving the real target echo of the object is T₆. Since the pulse laser beam emission time in two adjacent detection periods is relatively different, but the cancellation residue occurs at relatively the same time in the two detection periods, it can be determined that glare noise may exist in the ambient light in the two detection periods.

S604, adjusting a bias voltage at the receiving end of the LiDAR system in a case that the strong light noise exists in the echo light.

S604 corresponds to S404, which is not repeated herein.

It can be understood that, in the above embodiments, glare noise is identified by adjusting the time intervals of emitting the pulse laser beams. As can be seen from the above analysis, the cancellation residue may increase under the glare irradiation condition and may be erroneously detected as a target. But the occurrence time of the cancellation residue is related to the rising time of the bias voltage and is not related to the pulse laser beam emission time, but the real target echo position is not strongly related to the rising time of the cancellation bias voltage and is related to the pulse laser beam emission time. Therefore, in the embodiment of the present application, whether the echo light is a real target and has glare noise can be determined by adjusting the time interval of emitting the pulse laser beams in adjacent detection periods.

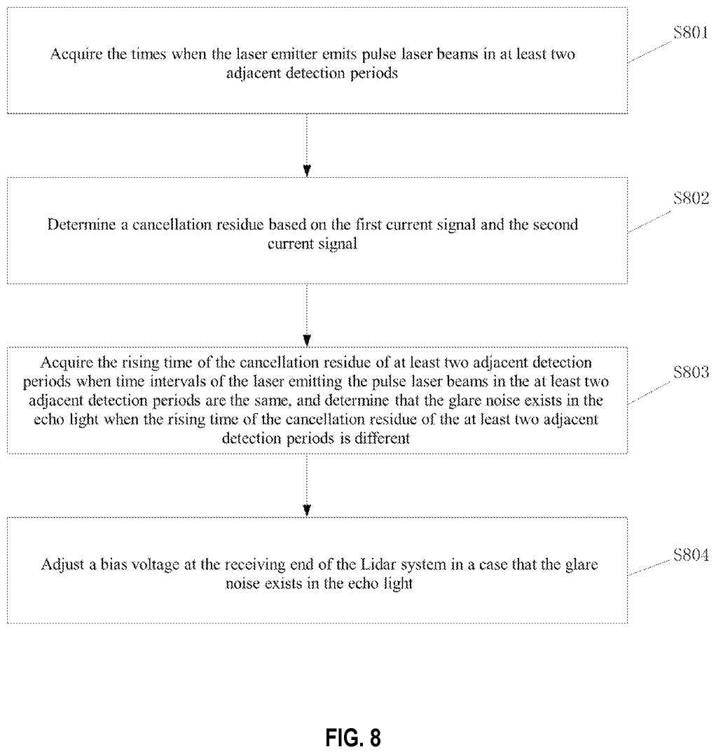

FIG. 8 schematically illustrates a schematic flowchart of another method for improving the laser beam ranging capability of a LiDAR system according to an embodiment of the present application. In a case that the emission power of the pulse laser beams of the laser emitter in at least two adjacent detection periods is different, as shown in FIG. 8, the method for improving the laser beam ranging capability of a LiDAR system at least includes the following steps.

S801, acquiring times when the laser emitter emits the pulse laser beams in the at least two adjacent detection periods.

S801 corresponds to S501, which is not repeated herein.

S802, determining a cancellation residue based on the first current signal and the second current signal.

S802 corresponds to S402, which is not repeated herein.

S803, acquiring rising times of cancellation residues of the at least two adjacent detection periods when time intervals of the laser emitter emitting the pulse laser beams in the at least two adjacent detection periods are the same, and determining that the glare noise exists in the echo light when the rising times of the cancellation residues of the at least two adjacent detection periods are different.

It can be understood that the same pulse laser beam emission time but different power of the laser emitter emitting the pulse laser beams in adjacent detection periods may result in different time moments of applying the bias voltages to the receiving sensor and the reference sensor.

In some embodiments, in two adjacent detection periods in the case of different emission powers, the pulse laser beam emission time T₁ in the first detection period 1S is 0.5 ms, and the pulse laser beam emission time T₄ in the second period 1S is also 0.5 ms. That is, in the case of the same emission time interval, the first current signal output by the receiving sensor and the second current signal output by the reference sensor in the two consecutive periods are acquired.

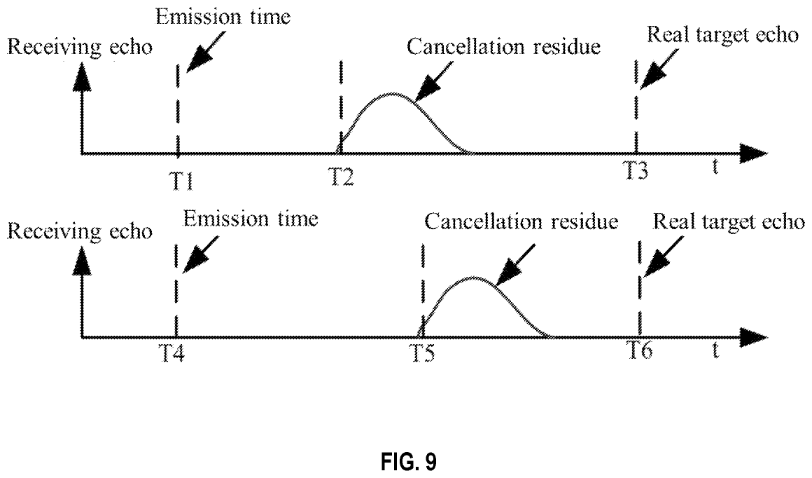

Referring to FIG. 9, the pulse laser beam emission time in the first detection period is T₁, the cancellation residue generation time is T₂, the time of receiving the real target echo of the object is T₃, the pulse laser beam emission time in the second detection period is T₄, the cancellation residue generation time is T₅, and the time of receiving the real target echo of the object is T₆. Since the emission time intervals of the pulse laser beams in two detection periods are the same, that is, the cancellation residue exists at relatively different time moments in adjacent detection periods, it can be determined that glare noise may exist in the ambient light in the two detection periods.

S804, adjusting a bias voltage at the receiving end of the LiDAR system in a case that the strong light noise exists in the echo light.

S804 corresponds to S404, which is not repeated herein.

It can be understood that, since the occurrence time of the cancellation residue is related to the rising time of the bias voltage and is not related to the pulse laser beam emission time, the real target echo position is not strongly related to the rising time of the cancellation bias voltage and is related to the pulse laser beam emission time. Therefore, in the embodiment of the present application, whether the echo light is a real target and has glare noise can be determined through the emission time of the pulse laser beams and the occurrence time of the cancellation residue.

In addition, in some embodiments, the method for improving the laser beam ranging capability of a LiDAR system provided in the embodiment of the present application may further include detecting whether glare noise exists in the environment in a case that the laser emitter is turned off. For example, a bias voltage greater than a breakdown voltage may be applied to the receiving sensor and the reference sensor such that the receiving sensor can receive the light noise, and then the numerical value of the cancellation residue is determined based on a first voltage corresponding to the receiving sensor and a second voltage corresponding to the reference sensor. The glare noise is determined to exist in the ambient light in the case that the numerical value of the cancellation residue is greater than the cancellation residue detection threshold.

In the embodiment of the present application, the control and signal processing unit may process the first current signal output by the receiving sensor in the adjacent detection period to obtain the first voltage and process the second current signal output by the reference sensor to obtain the second voltage.

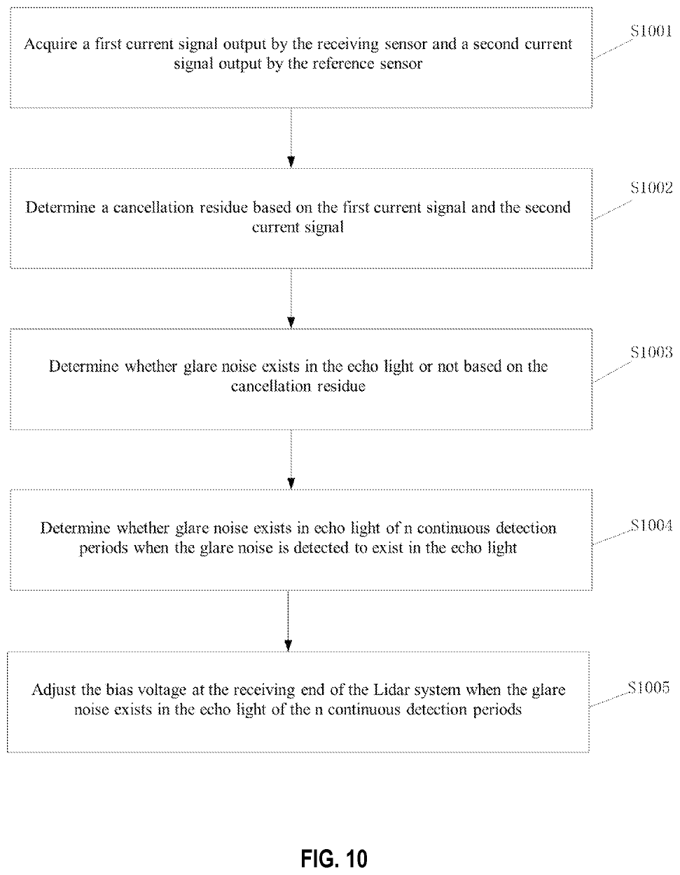

For example, in a detection period, the laser emitter at the emitting end does not emit pulse laser beams, but the receiving sensor at the receiving end is still turned on to receive echo light. Furthermore, bias voltages are applied to the receiving sensor and the reference sensor to acquire the cancellation residue generated by light noise, the numerical value of the cancellation residue is compared with a detection threshold of the cancellation residue. If the numerical value of the cancellation residue exceeds the detection threshold of the cancellation residue, it can be determined that glare irradiation exists in the current environment, and if the numerical value of the cancellation residue is not greater than the detection threshold of the cancellation residue, it can be determined that there is no glare irradiation in the current environment. It can be understood that the stronger the light noise is, the greater the numerical value of the cancellation residue is. FIG. 10 schematically illustrates a schematic flowchart of another method for improving the laser beam ranging capability of a LiDAR system according to an embodiment of the present application. As shown in FIG. 10, the method for improving the laser beam ranging capability of a LiDAR system may at least include the following steps.

S1001, acquiring a first current signal output by the receiving sensor and a second current signal output by the reference sensor.

S1001 corresponds to S401, which is not repeated herein.

S1002, determining a cancellation residue based on the first current signal and the second current signal.

S1002 corresponds to S402, which is not repeated herein.

S1003, determining whether glare noise exists in the echo light based on the cancellation residue.

S1003 corresponds to S403, which is not repeated herein.

S1004, determining whether glare noise exists in echo light of n continuous detection periods when the glare noise is detected to exist in the echo light.

In some embodiments, the receiving sensor in the embodiment of the present application may acquire n pulse laser beams emitting to the object by the pulse laser beam emitting end in n continuous detection periods. Furthermore, the receiving sensor may correspondingly output n first current signals and the reference sensor may correspondingly output n second current signals.

In the embodiment of the present application, a corresponding first voltage signal and a corresponding second voltage signal may be generated based on the first current signal output by the receiving sensor and the second current signal output by the reference sensor in each detection period. Furthermore, the numerical value of the cancellation residue in each detection period may be determined according to a waveform relation between the first voltage signal and the second voltage signal.

It can be understood that, in the case that the cancellation residue existing in each detection period is not 0, glare noise may exist in the echo light received by the receiving sensor.

S1005, when the strong light noise exists in the echo light of n continuous detection periods, adjusting the bias voltage at the receiving end of the LiDAR system.

In the embodiment of the present application, the bias voltage at the receiving end of the LiDAR system may be adjusted, based on a voltage reduction threshold, in m continuous detection periods.

In the embodiment of the present application, in the case that glare noise exists in echo light of n continuous detection periods, voltage is reduced and m detection periods are executed on the basis of an initial bias voltage value in each detection period to acquire detection distances of m detection periods, and after m times of glare distance detection is completed, the LiDAR system may exit from the glare detection mode to recover the voltage at the emitting end to the state before adjustment.

In the embodiment of the present application, the bias voltage at the receiving end of the LiDAR system can be reduced, and the point cloud filtering can be performed on the glare noise to avoid the problems caused by glare noise including the failure of the sensor due to high temperature, detection failure, false scenes, or the like.

In each of the above S603 and S803, whether the echo light is a real target and has glare noise is determined at the pulse laser beam emission time and the occurrence time of the cancellation residue. As can be seen from the foregoing, the occurrence time of the cancellation residue is related to the rising time of the bias voltage, and the rising time of the bias voltage is related to the length of the stray light time period.

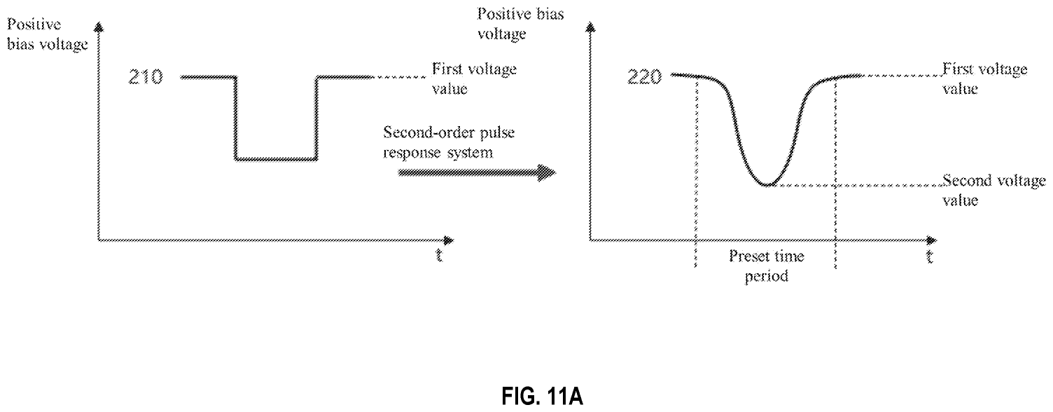

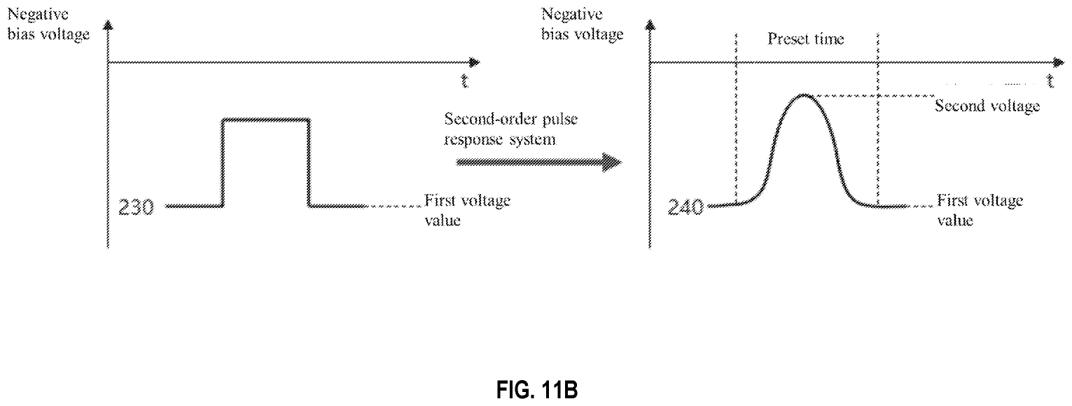

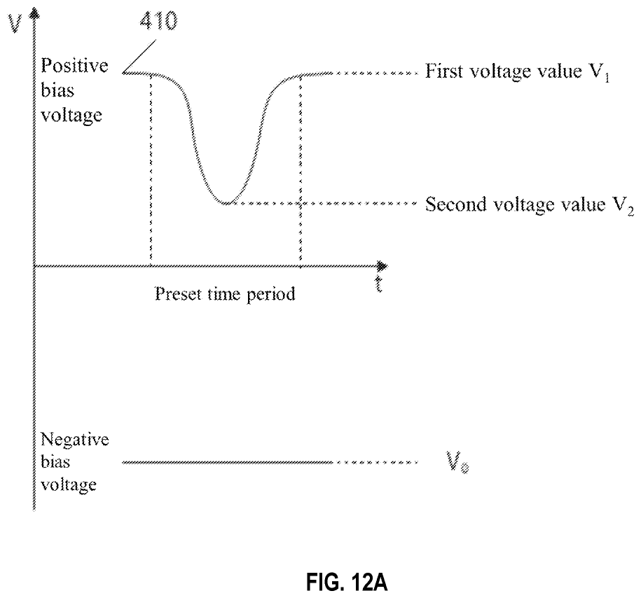

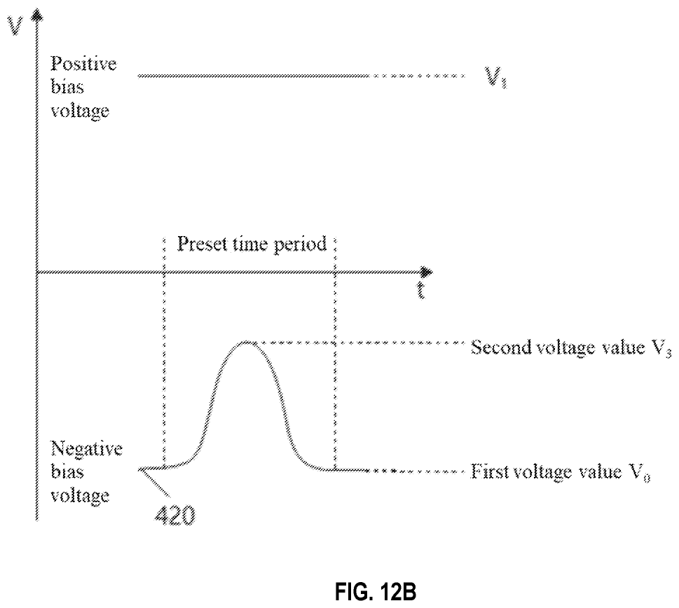

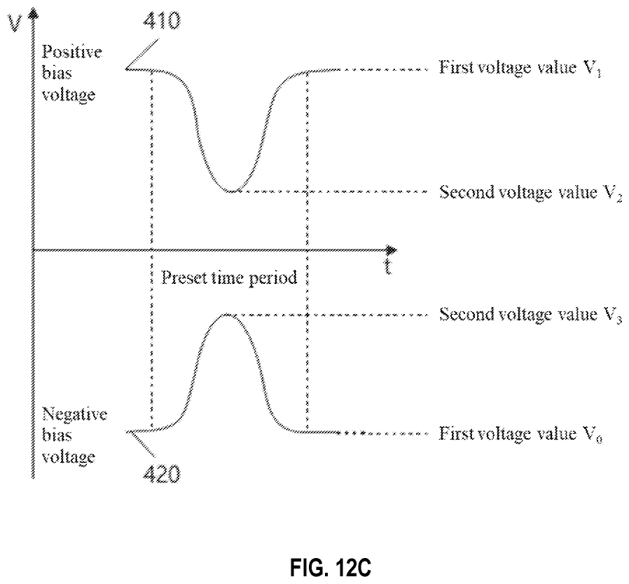

As shown in FIG. 12, the adjusting module includes a power supply sub-circuit, a negative bias voltage module 160 (i.e., negative electrode) of the power supply sub-circuit is connected to the anode of the receiving sensor, and a positive bias voltage module 150 (i.e., positive electrode) of the power supply sub-circuit is connected to the cathode of the receiving sensor. The positive bias voltage module 150 may include a second-order pulse response system, a positive power supply, or the like. The negative bias voltage module 160 may include a second-order pulse response system, a negative power supply, or the like. The second-order pulse response system includes a high voltage amplifier. As shown in FIG. 11A, the second-order pulse response system can convert a pulse 210 with a small amplitude and edge-jump step-change that is originally applied to the cathode of the receiving sensor 140 into a pulse 220 with a smooth edge and a relatively large amplitude, i.e., a relatively large difference between the first voltage value and the second voltage value. At this time, the width of the pulse is a time required for the positive bias voltage to change, i.e., a preset time period. As shown in FIG. 11B, the second-order pulse response system can convert a pulse 230 with a small amplitude and edge-jump step-change that is originally applied to the anode of the receiving sensor 140 into a pulse 240 with a smooth edge and a relatively large amplitude, i.e., a relatively large difference between the first voltage value and the second voltage value. At this time, the width of the pulse is a time required for the negative bias voltage to change, i.e., a preset time period.

An exemplary embodiment of the present application further provides a bias voltage control method. The control method includes the following step.

In step 301, the positive voltage and/or the negative voltage of the receiving sensor is continuously adjusted from the first voltage value to the second voltage value and from the second voltage value to the first voltage value in a preset time period.

In some embodiments, since the smaller the bias voltages at both ends of the receiving sensor are, the weaker the receiving capability thereof is, when the stray signal comes, the negative voltage of the receiving sensor is kept unchanged, and the stray signal can be suppressed by continuously adjusting the positive voltage of the receiving sensor. As shown in FIG. 12A, the positive voltage 410 of the receiving sensor can be directly and rapidly continuously adjusted and reduced from the first voltage value V1 to the second voltage value V2, and the positive voltage of the receiving sensor is ensured to be at the second voltage value V2 corresponding to the positive voltage at the time of receiving the stray light, so that the bias voltages at both ends of the receiving sensor are reduced from V1-V0 to V2-V0, and the receiving capability of the receiving sensor becomes weaker, thereby achieving the effect of suppressing the stray signal. The second voltage value V2 is smaller than the first voltage value V1. In order to achieve the effect of suppressing the stray signal better, the difference between the first voltage value V1 and the second voltage value V2 needs to be greater than a first preset threshold, for example, the difference may be 1V, 3V, or the like, which is not limited in the present application. The larger the first preset threshold is, the smaller the bias voltage between the positive voltage and the negative voltage of the receiving sensor is, the better the suppression effect on the stray signal is. In order not to affect normal short-distance ranging, the positive voltage of the receiving sensor needs to be continuously adjusted from the first voltage value V1 to the second voltage value V2 and from the second voltage value V2 to the first voltage value V1 in a preset time. The time length of the preset time period is smaller than the second preset threshold, and may be, for example, 50 ns or 100 ns, which is not limited in the present application. The smaller the second preset threshold is, the smaller the influence on the short-distance ranging in the process of suppressing the stray signal is.

In some embodiments, with the positive voltage of the receiving sensor kept unchanged, the effect of suppressing the stray signal can be achieved by continuously adjusting the negative voltage of the receiving sensor. As shown in FIG. 12B, when the stray signal comes, the negative voltage 420 of the receiving sensor can be directly and rapidly continuously adjusted and increased from the first voltage value V0 to the second voltage value V3, and the negative voltage of the receiving sensor is ensured to be at the second voltage value V3 at the time of receiving the stray light, so that the bias voltages at both ends of the receiving sensor are reduced from V1-V0 to V1-V3, and the receiving capability of the receiving sensor becomes weaker, thereby achieving the effect of suppressing the stray signal. The second voltage value V3 is greater than the first voltage value V0. In order to achieve the effect of suppressing the stray signal better, the difference between the first voltage value V0 and the second voltage value V3 needs to be greater than a first preset threshold, for example, the difference may be 1V, 3V, or the like, which is not limited in the present application. The larger the first preset threshold is, the smaller the bias voltage between the positive voltage and the negative voltage of the receiving sensor is, the better the suppression effect on the stray signal is. In order not to affect normal short-distance ranging, the negative voltage of the receiving sensor needs to be continuously adjusted from the first voltage value V0 to the second voltage value V3 and from the second voltage value V3 to the first voltage value V0 in a preset time. The time length of the preset time period is smaller than the second preset threshold, and may be, for example, 50 ns or 100 ns, which is not limited in the present application. The smaller the second preset threshold is, the smaller the influence on the short-distance ranging in the process of suppressing the stray signal is.

In some embodiments, it may continuously adjust the positive voltage and the negative voltage of the receiving sensor at the same time. As shown in FIG. 12C, when the stray signal comes, the positive voltage 410 of the receiving sensor can be directly and rapidly continuously adjusted and reduced from the first voltage value V1 to the second voltage value V2, and at the same time, the negative voltage 420 of the receiving sensor can be directly and rapidly continuously adjusted and increased from the first voltage value V0 to the second voltage value V3 through the second-order pulse response system, so that the positive voltage 410 of the receiving sensor is ensured to be at the second voltage value V2 and the negative voltage 420 thereof is ensured to be at the second voltage value V3 just at the time when the stray signal is received, then the bias voltages at both ends of the receiving sensor are reduced from V1-V0 to V2-V3, such that the receiving capability of the receiving sensor becomes weaker, thereby achieving the effect of suppressing the stray signal. The second voltage value V2 corresponding to the positive voltage 410 is smaller than the first voltage value V1 corresponding to the positive voltage 410. The second voltage value V3 corresponding to the negative voltage 420 is greater than the first voltage value V0 corresponding to the negative voltage 420. In order to achieve the effect of suppressing the stray signal better, the difference between the second voltage value V2 corresponding to the positive voltage 410 and the second voltage value V3 corresponding to the negative voltage 420 needs to be greater than a first preset threshold, for example, the difference may be 1V, 3V, or the like, which is not limited in the present application. The smaller the first preset threshold is, the smaller the bias voltage between the positive voltage and the negative voltage of the receiving sensor is, the better the suppression effect on the stray signal is. In order not to affect the normal short-distance ranging, the adjustment of the negative voltage 420 and the positive voltage 410 needs to be implemented in a preset time, and the time length of the preset time period is smaller than a second preset threshold, and may be, for example, 50 ns or 100 ns, which is not limited in the present application. The smaller the second preset threshold is, the smaller the influence on the short-distance ranging in the process of suppressing the stray signal is.

In some embodiments, in order to avoid the problem that the short-distance ranging is affected due to a relatively large oscillation caused by a too rapid abrupt change in the positive voltage and/or the negative voltage, the oscillation due to the variations in the positive voltage and/or the negative voltage can be reduced by means of continuous adjustment. Since the light speed of the laser beam emitted by the laser emitter is fast, the time when the receiving sensor receives the stray signal is approximately regarded as the time when the laser beam is emitted, that is, the time for continuously adjusting the positive voltage and/or the negative voltage of the receiving sensor from the first voltage value to the second voltage value is also fast, so that the starting time of the preset time period can be determined as the time when the LiDAR emits the laser beam. Then the positive voltage and/or the negative voltage of the receiving sensor can be continuously adjusted from the first voltage value to the second voltage value from the time when the laser beam is emitted, which is the time when the stray signal is received. That is, the positive voltage of the receiving sensor is at the second voltage value V2 shown in FIG. 4A and/or the negative voltage of the receiving sensor is at the second voltage value V3 shown in FIG. 4B just at the time when the stray signal is received by the receiving sensor. That is, the receiving capability of the receiving sensor is the weakest when the stray signal is received by the receiving sensor, so that the stray signal can be better suppressed.

In some embodiments, since the distances between the laser emitter and the light splitting unit and the receiving sensor are fixed, the time difference between the time when the laser emitter emits the laser beam and the time when the receiving sensor receives the stray signal is also fixed, thus the starting time of the preset time period can be set as the time when the LiDAR emits the laser beam. The time required for continuously adjusting and reducing the positive voltage and/or the negative voltage from the first voltage value to the second voltage value is aligned with the time difference between the time when the laser emitter emits the laser beam and the time when the receiving sensor receives the stray signal, then the positive voltage and/or the negative voltage of the receiving sensor is ensured to be at the second voltage value just at the time when the receiving sensor receives the stray signal. That is, the receiving capability of the receiving sensor is the weakest when the stray signal is received by the receiving sensor, so that the stray signal can be better suppressed.

In some embodiments, the second-order pulse response system is used to adjust the positive voltage and/or the negative voltage of the receiving sensor, so that the process of continuously adjusting the positive voltage and/or the negative voltage from the first voltage value to the second voltage value is smooth and rapid, i.e., no relatively large oscillation is caused and the response time is short. The voltage difference between the first voltage and the second voltage can also be ensured to achieve the effect of suppressing the stray signal, while not affecting the normal short-distance ranging.

In step 302, echo signals are received based on the positive voltage and the negative voltage of the receiving sensor.

As shown in FIG. 12A, the echo signals are received based on the bias voltage generated by the positive voltage 410 that is continuously adjusted in a preset time period at one end of the receiving sensor described above and the negative voltage V0 that is kept unchanged at the other end. The echo signals include a stray signal and a ranging signal. In the actual ranging process, the receiving sensor receives the stray signal first, so that when the laser emitter emits a laser beam, the positive voltage 410 of the receiving sensor is continuously adjusted from the first voltage value V1 to the second voltage value V2 and continuously adjusted from the second voltage value V2 to the first voltage value V1 in a preset time period simultaneously. The echo signals are received based on the continuously changed positive voltage 410 described above and the fixed negative voltage V0, thus achieving the effects of suppressing the stray signal and receiving the ranging signal without affecting the short-distance ranging.

As shown in FIGS. 12B and 12C, based on the continuous adjustment variations in the positive voltage and the negative voltage, it may achieve the effects of suppressing the stray signal and receiving the ranging signal without affecting the short-distance ranging as described above.

Due to the factors such as temperature change and device aging, a relationship between a starting time of the preset time period set by the factory and a time when the laser emitter emits the laser beams may change, which may cause time t1 when the receiving sensor receives the stray light to be later than time t0 when the positive voltage and/or the negative voltage is at the second voltage value. At this time, the positive voltage of the receiving sensor when receiving the stray light is V4, and the bias voltages V4-V0 at two corresponding ends are greater than the original bias voltages V2-V0. That is, the receiving capability of the receiving sensor becomes stronger, and at this time, the bias voltages at both ends of the receiving sensor are not enough to suppress the stray light. In order to solve the problem, on the basis of the bias voltage control method described above, the method further includes the following steps.

In step 303, whether the pulse amplitude of the stray light is greater than a third preset threshold is determined.

After the echo signal is received based on the positive voltage and the negative voltage of the receiving sensor, whether the pulse amplitude of the stray light in the echo signal received by the receiving sensor is greater than the third preset threshold needs to be determined. The third preset threshold is, for example, but not limited to, 1V, 2V, etc. It can be seen that the smaller the third preset threshold is, the higher the requirement of the suppression effect on the stray light by the LiDAR is, and the higher the ranging performance of the LiDAR is.

In step 304, if the pulse amplitude of the stray light is greater than the third preset threshold, the starting time of the preset time period is adjusted to obtain an updated starting time.

In some embodiments, if the pulse amplitude of the stray light described above is greater than the third preset threshold, the starting time of the preset time period needs to be adjusted according to a preset step length, so as to obtain an updated starting time. If the pulse amplitude of the stray light is greater than the third preset threshold, the starting time of the preset time period of the positive voltage and/or the negative voltage continuously adjusted in step 301 is adjusted backward by the preset step length to obtain the updated starting time. After the updated starting time is obtained, step 308 is executed, namely, an updated preset time period is obtained based on the updated starting time. Then, step 301 is executed again until the pulse amplitude of the stray light is smaller than or equal to the third preset threshold. The preset step length may be 0.5 ns, 1 ns, or the like, and may be set according to an actual short-distance ranging situation, which is not specifically limited in the present application. The updated starting time is later than the starting time before the update.

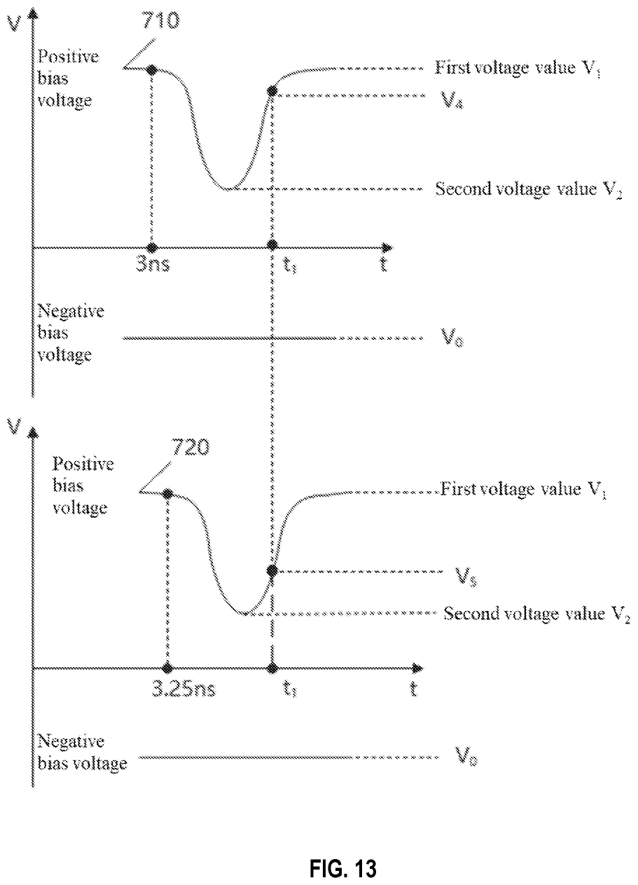

For example, if the negative voltage of the receiving sensor is kept unchanged in step 301 and the stray light is suppressed by continuously adjusting the positive voltage of the receiving sensor, when the receiving sensor receives the stray light at time t1 and the pulse amplitude of the stray light received at this time is greater than the third preset threshold and the preset step length is 0.25 ns, as shown in FIG. 13, the pulse 710 of the positive voltage of the receiving sensor corresponding to time t1 when the receiving sensor receives the stray light is V4. That is, the bias voltages V4-V0 at both ends of the receiving sensor are too large, the receiving capability of the receiving sensor is too strong, and the stray light cannot be suppressed well, and therefore the starting time 3 ns of the preset time period in the original pulse 710 of the positive voltage can be adjusted backward by 0.25 ns to obtain an updated starting time of 3.25 ns. After the updated starting time is obtained, step 308 is executed, namely, an updated preset time period is obtained based on the updated starting time. Then, step 301 is executed again, namely, the positive voltage and/or the negative voltage of the receiving sensor is continuously adjusted from the first voltage value to the second voltage value and from the second voltage value to the first voltage value in a preset time period. As can be seen from the pulse 720 of the positive voltage of the receiving sensor in FIG. 13, when the echo signal is received based on the pulse 720 of the positive voltage of the receiving sensor continuously adjusted in the updated preset time period and the constant negative voltage V0, the positive voltage of the receiving sensor corresponding to time t1 when the receiving sensor receives the stray light is V5, and as can be seen from FIG. 13, V5<V4. That is, the bias voltages at both ends of the receiving sensor are significantly reduced, and the receiving capability becomes weaker, so that whether the pulse amplitude of the received stray light based on the pulse 720 of the positive voltage of the receiving sensor and the negative voltage V0 can be determined again. If the pulse amplitude of the received stray light is greater than the third preset threshold at this time, step 304 is executed again until the pulse amplitude of the stray light is smaller than or equal to the third preset threshold.

In some embodiments, if the pulse amplitude of the stray light is greater than the third preset threshold, the starting time of the preset time period is adjusted according to the pulse amplitude of the stray light and the third preset threshold, so as to obtain an updated starting time. If the pulse amplitude of the stray light is greater than the third preset threshold and the pulse amplitude of the stray light is different from the third preset threshold by V, the pulse phase t2, which is the nearest time before time t1 corresponding to the pulse amplitude with a difference of V, is determined according to the pulse amplitude output by the second-order response system corresponding to the time when the stray light is received by the receiving sensor in the curve of variations in the continuously-adjusted positive voltage and/or negative voltage in step 301, then the time difference between t1 and t2 is obtained through calculation of t=t1−t2, and the starting time t0 of the preset time period is directly adjusted backward by t time lengths.

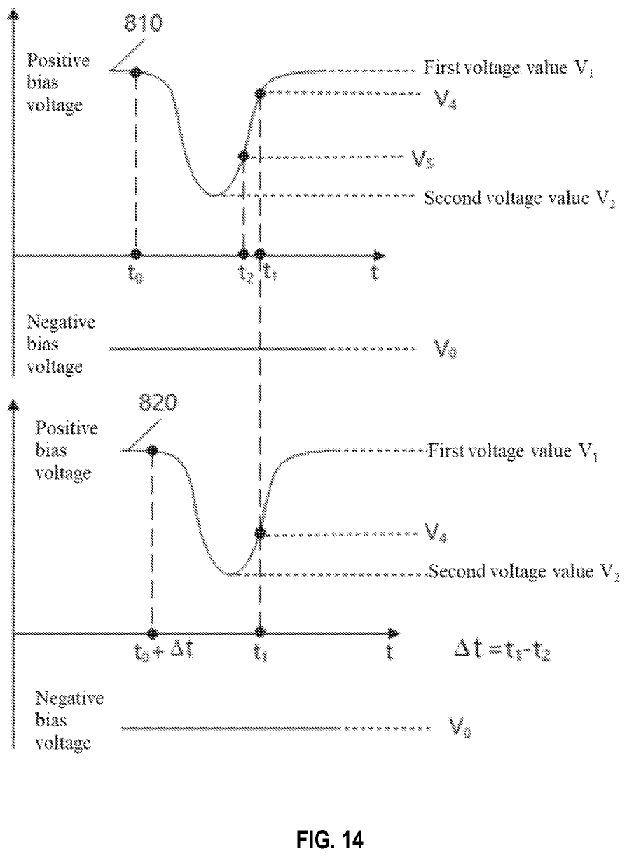

For example, if the negative voltage of the receiving sensor is kept unchanged in step 301 and the stray light is suppressed by continuously adjusting the positive voltage of the receiving sensor, when the difference between the pulse amplitude of the stray light and the third preset threshold is 2V, as shown in FIG. 14, the pulse phase t2, which is the nearest time beforetime t1 corresponding to the pulse amplitude V5 with a difference of 2V, can be determined according to the pulse amplitude V4 output by the second-order response system corresponding to time t1 when the receiving sensor receives the stray light in the pulse 810 output by the second-order response system, which is the positive voltage variation curve. Then, the time difference between t1 and t2 is obtained through the calculation of t=t1−t2, the starting time t0 of the preset time period is adjusted directly backward for Δt time lengths. Then, step 308 is executed, namely, an updated preset time period is obtained based on the updated starting time, so as to obtain the updated pulse 820. And step 301 is executed again, namely, the positive voltage and/or the negative voltage of the receiving sensor is continuously adjusted from the first voltage value to the second voltage value and from the second voltage value to the first voltage value in a preset time period. As can be seen from the pulse 820 of the positive voltage of the receiving sensor in FIG. 14, when the echo signal is received based on the pulse 820 of the positive voltage of the receiving sensor continuously adjusted in the updated preset time period and the constant negative voltage V0, the positive voltage of the receiving sensor corresponding to time t1 when the receiving sensor receives the stray light is V5. At this time, the stray light can be just suppressed. That is, when step 303 is executed, the pulse amplitude of the stray light can be determined to be equal to the third preset threshold, i.e., step 305 may be executed.

In step 305, if the pulse amplitude of the stray light is smaller than or equal to a third preset threshold, a corresponding minimum ranging distance is determined based on the ranging signal received by the receiving sensor.

In some embodiments, if the pulse amplitude of the stray light is smaller than or equal to the third preset threshold, the controller may determine a minimum ranging distance that can be measured according to all the measured distances corresponding to all the ranging signals that can be received by the receiving sensor.

In step 306, whether the minimum ranging distance is greater than a preset distance threshold is determined.

In some embodiments, after the minimum ranging distance that can be measured is determined, it is further required to determine whether the minimum ranging distance is greater than the preset distance threshold, that is, to determine whether the starting time of the preset time period in step 304 is adjusted excessively, which results in too small bias voltages at both ends of the receiving sensor, and the receiving capability thereof is too weak, which is equivalent to determine whether the adjustment of the starting time of the preset time period in step 304 described above affects normal short-distance ranging. The preset distance threshold may be 10 cm, 15 cm, or the like, and may be set according to the actual short-distance ranging performance and requirement of the LiDAR, which is not specifically limited in the present application.

In step 307, if the minimum ranging distance is greater than the preset distance threshold, the starting time of the preset time period is adjusted according to the preset step length to obtain the updated starting time.

In some embodiments, when the minimum ranging distance is greater than the preset distance threshold, the starting time of the preset time period is adjusted according to the preset step length to obtain the updated starting time. The updated starting time is earlier than the starting time before the update. That is, when the minimum ranging distance is greater than the preset distance threshold, the starting time t0 of the preset time period in the curve of variations in the positive voltage and/or the negative voltage continuously adjusted in step 301 may be adjusted forward by the preset step length, which is t time lengths, to obtain the updated starting time t0-Δt. Then, step 308 is executed, namely, an updated preset time period is obtained based on the updated starting time. A pulse corresponding to the updated positive voltage and/or negative voltage is obtained, then step 301 is executed again based on the updated preset time period. Namely, the positive voltage and/or the negative voltage of the receiving sensor is continuously adjusted from the first voltage value to the second voltage value and from the second voltage value to the first voltage value in a preset time period, until the minimum ranging distance is smaller than or equal to the preset distance threshold. Then, step 302 is directly executed, namely, echo signals are received based on the positive voltage and the negative voltage of the receiving sensor.

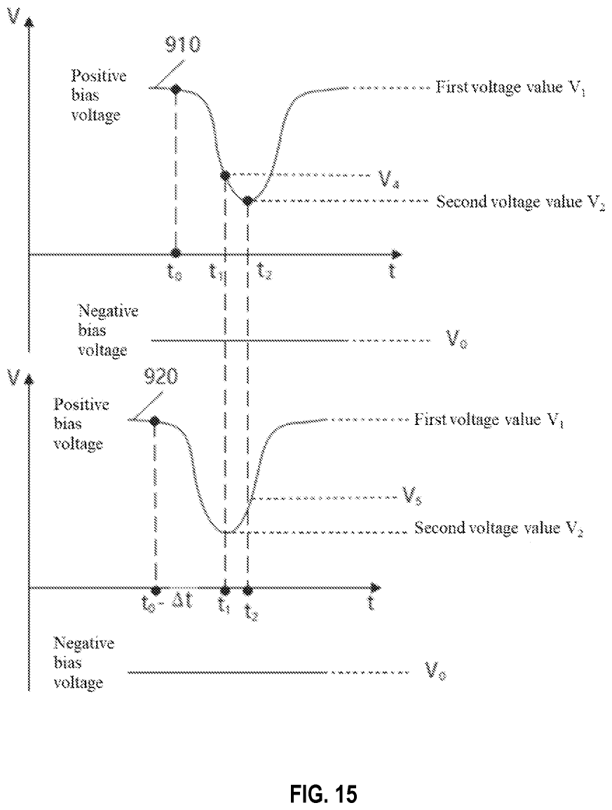

For example, if the negative voltage of the receiving sensor is kept unchanged in step 301, the stray light is suppressed by continuously adjusting the positive voltage of the receiving sensor. As shown in FIG. 15, when time t1 when the receiving sensor receives the stray light is at the falling edge of the positive voltage 910 due to the adjustment of the starting time of the preset time period in step 304 described above, the bias voltages at both ends of the receiving sensor corresponding to time t2 when the receiving sensor then receives the following ranging signal are much smaller than the bias voltages V4-V0 at both ends of the receiving sensor corresponding to time t1, and if the corresponding minimum ranging distance is 10 cm at this time and the preset distance threshold is 5 cm, the minimum ranging distance can be determined to be greater than the preset distance threshold. When the preset step length is t, in order to avoid affecting the normal short-distance ranging, the starting time t0 of the preset time period of the pulse 910 corresponding to the positive voltage may be adjusted forward by t time lengths, so as to obtain the updated starting time t0-Δt. Then, step 305 is executed, namely, an updated preset time period is obtained based on the updated starting time. A pulse 920 corresponding to the updated positive voltage is obtained, then step 301 is executed again based on the updated preset time period. Namely, the positive voltage and/or the negative voltage of the receiving sensor is continuously adjusted from the first voltage value to the second voltage value and from the second voltage value to the first voltage value in a preset time period. Then, step 302 is further executed, namely, echo signals are received based on the pulse 920 of the updated positive voltage and the fixed negative voltage V0. At this time, the positive voltage V5 corresponding to time t2 when the receiving sensor receives the ranging signal is significantly greater than the original positive voltage. Namely, the bias voltages at both ends of the receiving sensor become larger, the receiving capability becomes stronger, and the minimum distance capable of being measured also becomes smaller. Then, step 303 is executed again, until the minimum ranging distance is smaller than or equal to the preset distance threshold. Then, step 302 is directly executed, namely, echo signals are received based on the positive voltage and the negative voltage of the receiving sensor. The accuracy of the ranging result obtained after the echo signals are received in step 302 can be improved because the stray light is suppressed without affecting the short-distance ranging.

In step 308, an updated preset time period is obtained based on the updated starting time.

In some embodiments, based on the updated starting time in step 304 and step 307 described above, the updated preset time period can be obtained, namely, the starting time of the updated preset time period is the updated starting time, and the time length of the preset time period is kept unchanged.

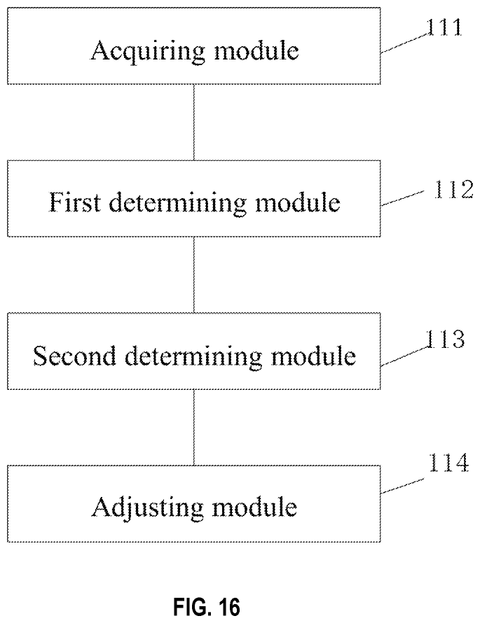

FIG. 16 is a schematic structural diagram of an apparatus for improving the laser beam ranging capability of a LiDAR system according to an exemplary embodiment of the present application. The apparatus for improving the laser beam ranging capability of a LiDAR system can be arranged in electronic devices such as terminal equipment to execute the method for improving the laser beam ranging capability of a LiDAR system in any embodiment described above. The LiDAR system includes: a laser emitter for emitting pulse laser beams, a receiving sensor for receiving echo light, and a reference sensor in a shading state, where the receiving sensor and the reference sensor are positioned at a receiving end of the LiDAR system. As shown in FIG. 16, the apparatus for improving the laser beam ranging capability of a LiDAR system includes:

an acquiring module 111, configured for acquiring a first current signal output by the receiving sensor and a second current signal output by the reference sensor;

a first determining module 112, configured for determining a cancellation residue based on the first current signal and the second current signal;

a second determining module 113, configured for determining whether glare noise exists in the echo light based on the cancellation residue; and

an adjusting module 114, configured for adjusting a bias voltage at the receiving end of the LiDAR system in a case that the glare noise exists in the echo light.

The adjusting module of the bias voltage of the LiDAR system may include a control sub-circuit, a detection sub-circuit, and a receiving sensor. The receiving sensor is configured for receiving the echo light signal and outputting a current signal. The detection sub-circuit is connected to the receiving sensor and is configured for detecting the temperature or the current of the receiving sensor. A first end of the control sub-circuit is connected with the detection sub-circuit, and a second end of the control sub-circuit is connected with the receiving sensor. The control sub-circuit is configured for emitting a first signal to the detection sub-circuit to enable the detection sub-circuit to detect the temperature or the current of the receiving sensor and receiving a detection result returned by the detection sub-circuit, and is further configured for determining a target bias voltage according to the received temperature or the received current and adjusting the voltage value applied to the anode and/or the cathode of the receiving sensor according to the target bias voltage.

In some embodiments, the control sub-circuit determines a target bias voltage corresponding to the temperature or the current according to a preset mapping relation, and adjusts the voltage applied to the anode and/or the cathode of the receiving sensor according to the target bias voltage. The preset mapping relation may be a temperature-bias voltage relation or a current-bias voltage relation. Due to the increase of the current, the heating effect of the receiving sensor may be intensified, and the temperature of the receiving sensor may increase. The current or the temperature may be detected, or both the current and the temperature may be detected simultaneously. The receiving capacity of the receiving sensor is related to the bias voltage. When the bias voltage of the same receiving sensor is unchanged, the receiving capability is different due to the change in the working temperature. The selected receiving sensor may obtain its temperature-bias voltage relation curve or current-bias voltage relation curve through measurement.

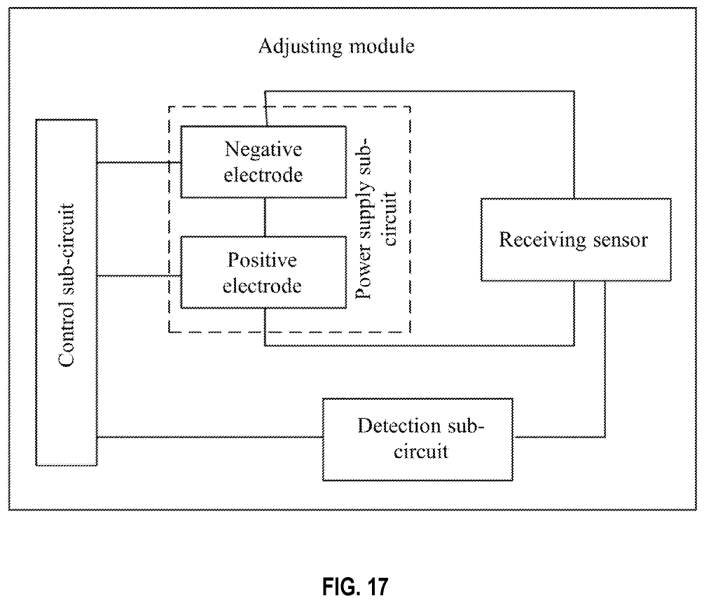

As shown in FIG. 17, the adjusting module may include a power supply sub-circuit. A negative electrode of the power supply sub-circuit is connected to an anode of the receiving sensor, and a positive electrode of the power supply sub-circuit is connected to a cathode of the receiving sensor. The control sub-circuit determines the duty ratio of the modulation signal applied to the negative electrode and/or the positive electrode of the power supply sub-circuit based on the target bias voltage. The positive electrode and/or the negative electrode of the power supply sub-circuit receives the modulation signal sent by the control sub-circuit and outputs power according to the modulation signal. For example, the control sub-circuit detects a voltage value applied to the cathode of the receiving sensor; the voltage value required to be applied to the anode of the receiving sensor is determined according to the target bias voltage and the voltage value applied to the cathode of the receiving sensor; the duty ratio of a modulation signal of the negative electrode of the power supply sub-circuit is determined according to the voltage value of the anode of the receiving sensor, and the modulation signal is sent to the negative electrode of the power supply sub-circuit. Or, the control sub-circuit detects a voltage value applied to the anode of the receiving sensor; the voltage value required to be applied to the cathode of the receiving sensor is determined according to the voltage value of the target bias voltage applied to the anode of the receiving sensor; the duty ratio of a modulation signal of the positive electrode of the power supply sub-circuit is determined according to the voltage value of the cathode of the receiving sensor, and the modulation signal is sent to the positive electrode of the power supply sub-circuit. When the receiving sensor is in a normal working state, the temperature or current of the receiving sensor may also be changed due to slow temperature change caused by factors such as working environmental temperature, self temperature rise, and device aging. At this moment, the bias voltage of the receiving sensor is adjusted to be in a good working state by sending modulation signals with different duty ratios to the positive electrode and/or the negative electrode of the power supply sub-circuit through the control sub-circuit, thus realizing the dynamic adjustment of the bias voltage during the working period of the receiving sensor, and improving the distance measurement range and the reliability of the LiDAR system.

The adjustment circuit may also include a voltage dividing sub-circuit. One end of the voltage dividing sub-circuit is connected to the anode of the power supply sub-circuit, and the other end of the voltage dividing sub-circuit is connected to the cathode of the receiving sensor. The voltage-dividing sub-circuit is connected in series between the receiving sensor and the anode, and can share part of voltage to generate relatively large voltage drop. The positive voltage value of the cathode of the receiving sensor is reduced, and the bias voltages at both ends of the receiving sensor are reduced. When the receiving sensor receives more light, the generated induced current is larger, the voltage drop generated by the voltage dividing sub-circuit is also larger, the bias voltage of the receiving sensor can be effectively reduced, thus avoiding the supersaturation condition. In some embodiments, the voltage dividing sub-circuit may be a resistor module, and the resistor module may generate different voltage drops according to the magnitude of the induced current. The larger the induced current is, the larger the voltage drop is, and the smaller the induced current is, the smaller the voltage drop is. The circuit is simple without the need of complex control to utilize inherent properties of the device.

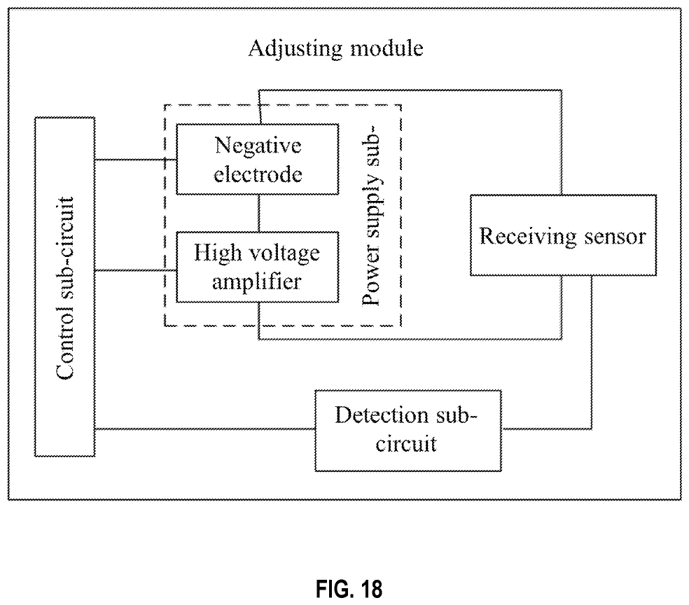

However, if the resistance of the series voltage dividing sub-circuit is too small, the active voltage drop effect is not obvious for the sharp increase of the induced current caused by the glare, and if the resistance is too large, the voltage drop in the normal working state is too large, which affects the ranging capability of the receiving sensor. In order to address the above problem, as shown in FIG. 18, the adjusting module may include a power supply sub-circuit. A negative electrode of the power supply sub-circuit is connected to the anode of the receiving sensor, and a positive electrode of the power supply sub-circuit is connected to the cathode of the receiving sensor. The positive electrode of the power supply sub-circuit is set as a high-voltage amplifier and is connected to the cathode of the receiving sensor, and the high-voltage amplifier receives the switching signal sent by the control sub-circuit and switches gears according to the received switching signal to output different positive voltage values. In some embodiments, the control sub-circuit sends a low-gear switching signal to the high-voltage amplifier, and the high-voltage amplifier outputs a low-gear positive voltage value, such as 1V; the control sub-circuit sends a high-gear switching signal to the high-voltage amplifier, and the high-voltage amplifier outputs a high-gear positive voltage value, such as 5V. The positive voltage value output by the high-voltage amplifier may also include a plurality of gears, such as 3 or 10 gears, which can be set according to an adjustment requirement and is not limited herein. When the receiving sensor is irradiated by glare, a large photocurrent is instantaneously generated, the temperature or current of the receiving sensor is suddenly changed, a positive voltage value is instantaneously pulled to a low gear by controlling a high-voltage amplifier with quick response, the bias voltage of the receiving sensor is quickly adjusted to be low, and a strong echo signal can be effectively received while the device is prevented from being damaged. When the glare irradiation is finished, the temperature or the current of the receiving sensor is reduced, the positive voltage value is switched back to a high gear by controlling the high-voltage amplifier, and the normal working state is recovered, thereby avoiding the instant blindness of the LiDAR system caused by glare irradiation and improving the detection capability.

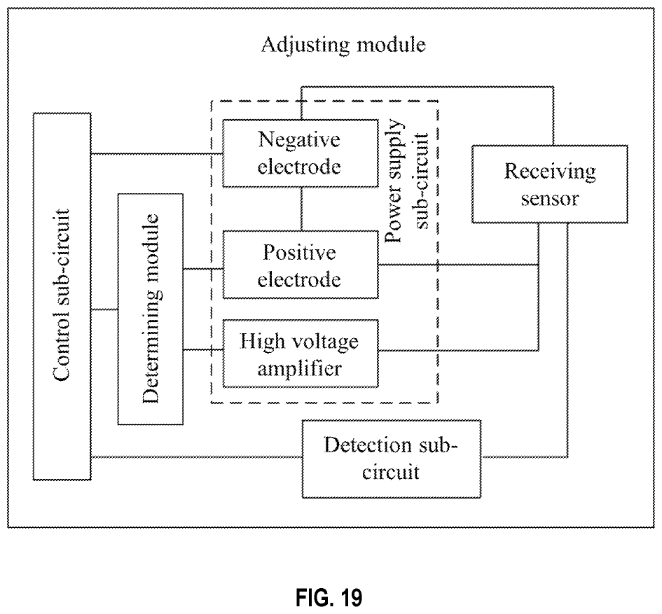

As shown in FIG. 19, the adjusting module may include a power supply sub-circuit and a determining module. A negative electrode of the power supply sub-circuit is connected to the anode of the receiving sensor, a first end of a positive electrode of the power supply sub-circuit is directly connected to the cathode of the receiving sensor, and a second end of the positive electrode of the power supply sub-circuit is set as a high voltage amplifier and connected to the cathode of the receiving sensor. The first end and the second end of the positive electrode of the power supply sub-circuit may both output powers to the cathode of the receiving sensor. The positive electrode and/or the negative electrode of the power supply sub-circuit receives the modulation signal sent by the control sub-circuit and outputs a power according to the modulation signal; the high-voltage amplifier receives the switching signal sent by the control sub-circuit and switches gears according to the received switching signal to output different positive voltage values. The determining module is configured for determining whether the temperature or the current of the receiving sensor meets a preset condition and selecting a receiver to which a signal is sent according to the determination result. The receiver is either the positive electrode and/or the negative electrode of the power supply sub-circuit or the high-voltage amplifier. In some embodiments, the control sub-circuit receives the temperature or the current of the receiving sensor, and the determining module determines whether the temperature or the current of the receiving sensor meets a preset condition. If yes, the target bias voltage of the receiving sensor is determined, and a switching signal is sent to the high-voltage amplifier to enable the high-voltage amplifier to output a positive voltage value of a corresponding gear; if no, the target bias voltage of the receiving sensor is determined, and a modulation signal is sent to the positive electrode of the power supply sub-circuit. The preset condition met by the temperature or the current of the receiving sensor refers to a sudden change in the temperature or the current. The temperature or the current of the receiving sensor detected by the detection sub-circuit at the current time may be compared with the previous detection result. If the difference value of the two detection results is greater than the threshold, the temperature or the current of the receiving sensor is considered to be suddenly changed; and if the difference value of the two detection results is smaller than or equal to the threshold, the temperature or the current of the receiving sensor is considered to have no sudden change. When the temperature or the current of the receiving sensor changes suddenly, it means that a large photocurrent is instantaneously generated, with the receiving sensor being irradiated by glare, a positive voltage value is instantaneously pulled to a low gear by controlling a high-voltage amplifier with quick response, the bias voltage of the receiving sensor is quickly adjusted to be low, and a strong echo signal can be effectively received while the device is prevented from being damaged. When the glare irradiation is finished, the temperature or the current of the receiving sensor is reduced, the positive voltage value is switched back to a high gear by controlling the high-voltage amplifier, and the normal working state is recovered. When the temperature or the current of the receiving sensor does not change suddenly, it means that the receiving sensor is in a normal working state, and a bias voltage does not need to be adjusted instantaneously and quickly. However, the temperature or current of the receiving sensor can also be changed due to slow temperature change caused by factors such as the working environmental temperature of the receiving sensor, the self temperature rise, and the device aging. At this situation, the bias voltage of the receiving sensor is adjusted to be in a good working state by sending modulation signals with different duty ratios to the positive electrode and/or the negative electrode of the power supply sub-circuit through the control sub-circuit, thus realizing the dynamic adjustment of the bias voltage during the working period of the receiving sensor, and improving the distance measurement range and the reliability of the LiDAR system.

In the embodiment of the present application, a first current signal output by a receiving sensor and a second current signal output by a reference sensor are acquired; a cancellation residue is determined based on the first current signal and the second current signal; whether glare noise exists in echo light is determined based on the cancellation residue; and a bias voltage at a receiving end of the LiDAR system is adjusted in a case that the glare noise exists in the echo light. Therefore, in the embodiment of the present application, whether glare noise exists in the echo light can be detected by arranging the receiving sensor and the reference sensor at the receiving end of the LiDAR system. If yes, the bias voltage at the receiving end is reduced to reduce the average current of the receiving sensor and reduce noise excitation, thus improving the ranging accuracy of the LiDAR system.

In some embodiments, the power of the pulse laser beams emitted by the laser emitter in at least two adjacent detection periods are the same. Before the acquiring module 111, the apparatus further includes:

a first-time acquiring module, configured for acquiring times when the laser emitter emits the pulse laser beams in the at least two adjacent detection periods; and

the second determining module 113, configured for:

acquiring rising times of the cancellation residues of the at least two adjacent detection periods when time intervals of the laser emitter emitting the pulse laser beams in the at least two adjacent detection periods are different, and determining that the glare noise exists in the echo light when the rising times of the cancellation residues of the at least two adjacent detection periods are the same.

In some embodiments, the emission powers of the pulse laser beams emitted by the laser emitter in at least two adjacent detection periods are different.

Before the acquiring module 111, the apparatus further includes:

a first-time acquiring module, configured for acquiring times when the laser emitter emits the pulse laser beams in the at least two adjacent detection periods; and the second determining module 113, configured for:

acquiring rising times of the cancellation residues of the at least two adjacent detection periods when time intervals of the laser emitter emitting the pulse laser beams in the at least two adjacent detection periods are the same, and determining that the glare noise exists in the echo light when the rising times of the cancellation residues of the at least two adjacent detection periods are different.

In some embodiments, before the acquiring module 111, the apparatus further includes:

a bias voltage control signal applying module, configured for turning off the laser emitter and applying a preset bias control signal to the receiving sensor and the reference sensor; where the preset bias control signal controls the bias voltage at the receiving end to be smaller than a breakdown voltage in a stray light time period, and controls the bias voltage at the receiving end to be greater than the breakdown voltage in an echo light time period.

In some embodiments, the adjusting module 114 includes: a judging unit configured for determining whether glare noise exists in echo light of n continuous detection periods when the glare noise is detected to exist in the echo light; and an adjusting unit configured for adjusting the bias voltage at the receiving end of the LiDAR system when the strong light noise exists in the echo light of the n continuous detection periods.

In some embodiments, the adjusting unit is configured for:

adjusting the bias voltage at the receiving end of the LiDAR system, based on a voltage reduction threshold, in m continuous detection periods.

In some embodiments, after the adjusting module 114, the apparatus further includes: a filter module configured for performing point cloud filtering on the glare noise.

It should be noted that, when the apparatus for improving the laser beam ranging capability of a LiDAR system according to the above embodiments implements the method for improving the laser beam ranging capability of a LiDAR system, only the division of the above functional modules is illustrated. In practical applications, the above function may be achieved by different functional modules as needed; that is, the internal structure of the device is divided into different functional modules to complete all or part of the above described functions. In addition, the apparatus for improving the laser beam ranging capability of a LiDAR system according to the above embodiments and the embodiment of the method for improving the laser beam ranging capability of a LiDAR system belong to the same concept, and the detailed implementation process is shown in the method embodiments, which is not repeated herein.

The above serial numbers of the embodiments of the present application are merely for description, and do not represent the advantages and disadvantages of the embodiments.

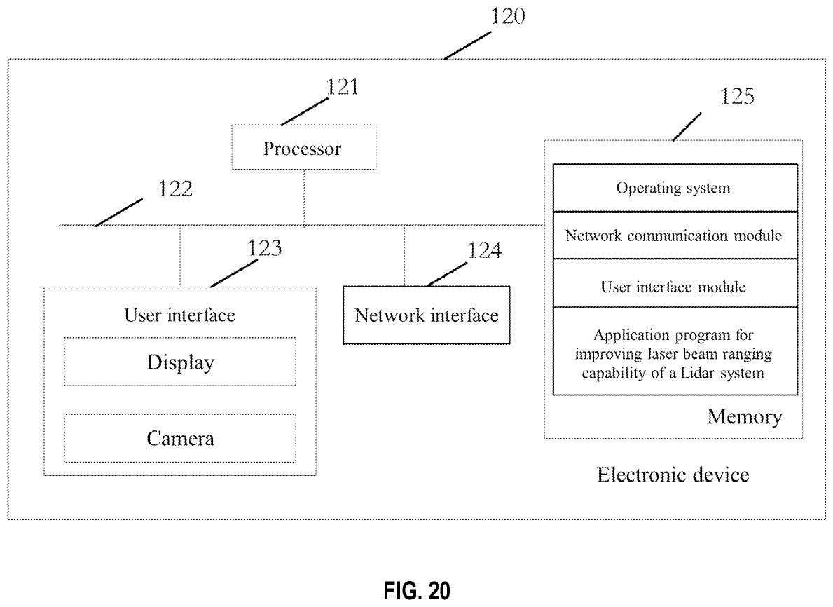

FIG. 20 shows a schematic structural diagram of an electronic device according to an embodiment of the present application. As shown in FIG. 20, the electronic device 120 may include: at least one processor 121, at least one network interface 124, a user interface 123, a memory 125, and at least one communication bus 122.

The communication bus 122 is configured for implementing connection communication among these components.

The user interface 123 may include a display and a camera, and the user interface 123 may include a standard wired interface and a wireless interface.

The network interface 124 may include a standard wired interface and a wireless interface (e.g., WI-FI interface).

The processor 121 may include one or more processing cores. The processor 121 connects all parts of the entire electronic device 120 by utilizing various interfaces and circuits, implements various functions of the electronic device 120 and processes data by running or executing instructions, programs, code sets, or instruction sets stored in the memory 125 and by calling data stored in the memory 125. The processor 121 may be implemented in at least one hardware form of digital signal processing (DSP), field-programmable gate array (FPGA), and programmable logic array (PLA). The processor 121 may integrate one or a combination of a central processing unit (CPU), a graphics processing unit (GPU), a modem, or the like. The CPU mainly processes an operating system, a user interface, an application program, or the like. The GPU is configured for rendering and drawing the content required to be displayed by the display; the modem is configured for handling wireless communications. It can be understood that the above modem may not be integrated into the processor 121, and may be implemented by a single chip.

The memory 125 may include a random access memory (RAM) or a read-only memory (ROM). The memory 125 includes a non-transitory computer-readable storage medium. The memory 125 may be configured for storing an instruction, a program, a code, a code set, or an instruction set. The memory 125 may include a storage program area and a storage data area. The storage program area may store instructions for implementing an operating system, instructions for at least one function (such as a touch function, a sound playing function, and an image playing function), instructions for implementing the above method embodiments, or the like; the storage data area may store data and the like referred to in the above method embodiments. The memory 125 may alsobe at least one storage apparatus located remotely from the processor 121 described above. As shown in FIG. 15, the memory 125, as a computer storage medium, may include an operating system, a network communication module, a user interface module, and an application program for improving laser beam ranging capability of a LiDAR system.

In the electronic device 120 shown in FIG. 15, the user interface 123 is mainly configured as an interface for providing inputs for users and acquiring data input by users; the processor 121 may be configured for calling the application program for improving laser beam ranging capability of a LiDAR system stored in the memory 125, and the operations may be performed as follows:

acquiring a first current signal output by the receiving sensor and a second current signal output by the reference sensor;

determining a cancellation residue based on the first current signal and the second current signal;

determining whether glare noise exists in the echo light based on the cancellation residue; and

adjusting a bias voltage at the receiving end of the LiDAR system in a case that the strong light noise exists in the echo light.

In some embodiments, the power of the pulse laser beams emitted by the laser emitter in at least two adjacent detection periods are the same. The processor 121, before implementing the step of acquiring a first current signal output by the receiving sensor and a second current signal output by the reference sensor, further implements:

acquiring times when the laser emitter emits the pulse laser beams in the at least two adjacent detection periods; and

the processor 121, when executing the step of determining whether glare noise exists in the echo light based on the cancellation residue, executes:

acquiring rising times of cancellation residues of the at least two adjacent detection periods when time intervals of the laser emitter emitting the pulse laser beams in the at least two adjacent detection periods are different, and determining that the glare noise exists in the echo light when the rising times of the cancellation residues of the at least two adjacent detection periods are the same.

In some embodiments, the power of the pulse laser beams emitted by the laser emitter in at least two adjacent detection periods are the same; the processor 121, before implementing the step of acquiring a first current signal output by the receiving sensor and a second current signal output by the reference sensor, further implements:

acquiring times when the laser emitter emits the pulse laser beams in the at least two adjacent detection periods; and

the processor 121, when executing the step of determining whether glare noise exists in the echo light based on the cancellation residue, executes:

acquiring rising times of cancellation residues of the at least two adjacent detection periods when time intervals of the laser emitter emitting the pulse laser beams in the at least two adjacent detection periods are the same, and determining that the glare noise exists in the echo light when the rising times of the cancellation residues of the at least two adjacent detection periods are different.

In some embodiments, the processor 121, before implementing the step of acquiring a first current signal output by the receiving sensor and a second current signal output by the reference sensor, further implements:

turning off the laser emitter; and

applying a preset bias control signal to the receiving sensor and the reference sensor, where the preset bias control signal controls the bias voltage at the receiving end to be smaller than a breakdown voltage in a stray light time period, and controls the bias voltage at the receiving end to be greater than the breakdown voltage in an echo light time period.

In some embodiments, the processor 121, when implementing the step of adjusting a bias voltage at the receiving end of the LiDAR system in a case that the strong light noise exists in the echo light, implements:

determining whether glare noise exists in echo light of n continuous detection periods when the glare noise is detected to exist in the echo light; and adjusting the bias voltage at the receiving end of the LiDAR system when the strong light noise exists in the echo light of the n continuous detection periods.

In some embodiments, the processor 121, when implementing the step of adjusting the bias voltage at the receiving end of the LiDAR system, implements:

adjusting the bias voltage of the receiving end of the LiDAR system, based on a voltage reduction threshold, in m continuous detection periods.

In some embodiments, the processor 121, after implementing the step of adjusting a bias voltage at the receiving end of the LiDAR system in a case that the strong light noise exists in the echo light, further implements: performing point cloud filtering on the glare noise.

The embodiment of the present application also provides a computer readable storage medium. The computer readable storage medium has an instruction stored thereon, where the instruction, when executed on a computer or a processor, causes the computer or the processor to implement one or more of the steps in the embodiments shown in FIGS. 4, 6, 8 and 10 as described above. The respective constituent modules of the apparatus for improving the laser beam ranging capability of a LiDAR system described above may be stored in the computer-readable storage medium if they are implemented in the form of software functional units and sold or used as independent products.

In the above embodiments, all or part of the implementation may be realized using software, hardware, firmware, or any combination thereof.

The implementation, when realized using software, may be realized in whole or in part in the form of a computer program product. The computer program product includes one or more computer instructions. The procedures or functions described in accordance with the embodiments of the present application are all or partially generated when the computer program instructions are loaded and executed on a computer. The computer may be a general-purpose computer, a special-purpose computer, a computer network, or other programmable apparatuses. The computer instructions may be stored on or transmitted over a computer-readable storage medium. The computer instructions may be transmitted from one website, computer, server or data center to another website, computer, server, or data center in a wired (e.g., coaxial cable, fiber optic, and digital subscriber line (DSL)) or wireless (e.g., infrared, wireless, and microwave) manner. The computer-readable storage medium may be any available medium that can be accessed by a computer or a data storage device, such as a server and a data center, that includes one or more available media. The available medium may be a magnetic medium (e.g., a soft disk, a hard disk, or a magnetic tape), an optical medium (e.g., a digital versatile disc (DVD)), or a semiconductor medium (e.g., a solid state disk (SSD)), and the like.

It can be understood by those of ordinary skill in the art that all or a part of the procedures of the methods in the embodiments described above may be implemented by a computer program instructing relevant hardware. The program may be stored in a computer-readable storage medium; and the program, when executed, may include the procedures in the embodiments of the methods described above. The aforementioned storage medium includes a read-only memory (ROM), a random access memory (RAM), a magnetic disk, an optical disk, or other media capable of storing program codes. The embodiments and technical features thereof in the present application may be combined with one another without conflict.

The above embodiments are only exemplary embodiments of the present application, and are not intended to limit the scope of the present application, and various modifications and improvements made to the technical solutions of the present application by those skilled in the art without departing from the design spirit of the present application should fall within the protection scope defined by the claims of the present application.

What is claimed is:

1. A method for improving ranging capability of a LiDAR system, wherein the LiDAR system comprises: a laser emitter for emitting pulse laser beams, a receiving sensor for receiving echo lights, and a reference sensor in a shading state, and
wherein the receiving sensor and the reference sensor are arranged at a receiving end of the LiDAR system, the method comprising:
acquiring a first current signal output by the receiving sensor and a second current signal output by the reference sensor;
determining a cancellation residue based on the first current signal and the second current signal;
determining whether glare noise exists in the echo lights based on the cancellation residue; and
if the glare noise exists in the echo lights, adjusting a bias voltage at the receiving end of the LiDAR system.

2. The method according to claim 1, wherein powers of the pulse laser beams emitted by the laser emitter in at least two adjacent detection periods are the same,
before acquiring the first current signal output by the receiving sensor and the second current signal output by the reference sensor, the method further comprising:
acquiring times when the laser emitter emits the pulse laser beams in the at least two adjacent detection periods; and
determining whether glare noise exists in the echo lights based on the cancellation residue comprises:
acquiring rising times of cancellation residues of the at least two adjacent detection periods when time intervals of the laser emitter emitting the pulse laser beams in the at least two adjacent detection periods are different, and determining that the glare noise exists in the echo lights when the rising times of the cancellation residues of the at least two adjacent detection periods are the same.

3. The method according to claim 1, wherein powers of the pulse laser beams emitted by the laser emitter in at least two adjacent detection periods are different,
before acquiring the first current signal output by the receiving sensor and the second current signal output by the reference sensor, the method further comprising:
acquiring times when the laser emitter emits the pulse laser beams in the at least two adjacent detection periods; and
determining whether glare noise exists in the echo lights based on the cancellation residue comprises:
acquiring rising times of cancellation residues of the at least two adjacent detection periods when time intervals of the laser emitter emitting the pulse laser beams in the at least two adjacent detection periods are the same, and determining that the glare noise exists in the echo lights when the rising times of the cancellation residues of the at least two adjacent detection periods are different.

4. The method according to claim 1, wherein, before acquiring the first current signal output by the receiving sensor and the second current signal output by the reference sensor, the method further comprises:
turning off the laser emitter; and
applying a preset bias control signal to the receiving sensor and the reference sensor, wherein the preset bias control signal controls the bias voltage of the receiving end to be smaller than a breakdown voltage in a stray light period, and to be greater than the breakdown voltage in an echo light period.

5. The method according to claim 1, wherein adjusting the bias voltage at the receiving end of the LiDAR system comprises:
determining whether the glare noise exists in echo lights of n continuous detection periods when the glare noise is detected to exist in the echo lights; and
if the glare noise exists in the echo lights of the n continuous detection periods, adjusting the bias voltage at the receiving end of the LiDAR system.

6. The method according to claim 5, wherein, if the glare noise exists in the echo lights of the n continuous detection periods, adjusting the bias voltage at the receiving end of the LiDAR system comprises:
adjusting, based on a voltage reduction threshold, the bias voltage at the receiving end of the LiDAR system in m continuous detection periods.

7. The method according to claim 5, wherein adjusting the bias voltage at the receiving end of the LiDAR system further comprises:
acquiring a temperature or a current of the receiving sensor;
determining a target bias voltage according to the temperature or the current; and
adjusting a voltage value applied to at least one of an anode or a cathode of the receiving sensor according to the target bias voltage.

8. The method according to claim 7, wherein adjusting the voltage value applied to at lease one of the anode or the cathode of the receiving sensor according to the target bias voltage further comprises:
determining whether the temperature or the current of the receiving sensor meets a preset adjustment;
if yes, determining a duty ratio of a modulation signal applied to at least one of a negative electrode or a positive electrode of a power supply module according to the target bias voltage; and
if no, determining a switching signal applied to a high-voltage amplifier of the power supply module according to the target bias voltage, wherein the high-voltage amplifier switches gears according to the received switching signal to output different positive voltage values.

9. The method according to claim 1, wherein, after adjusting the bias voltage at the receiving end of the LiDAR system, the method further comprises: performing point cloud filtering on the glare noise.

10. An apparatus for improving laser beam ranging capability of a LiDAR system, wherein the LiDAR system comprises: a laser emitter for emitting pulse laser beams, a receiving sensor for receiving echo lights, and a reference sensor in a shading state, and
wherein the receiving sensor and the reference sensor are positioned at a receiving end of the LiDAR system, the apparatus comprising:
an acquiring module, configured for acquiring a first current signal output by the receiving sensor and a second current signal output by the reference sensor;
a first determining module, configured for determining a cancellation residue based on the first current signal and the second current signal;
a second determining module, configured for determining whether glare noise exists in the echo lights based on the cancellation residue; and
an adjusting module, configured for adjusting a bias voltage at the receiving end of the LiDAR system in a case that the glare noise exists in the echo lights.

11. A LiDAR comprising a processor and a memory, wherein the memory has a computer program stored thereon, and the computer program, when loaded and executed by the processor, implements the method according to claim 1.
